(19) United States
(12) Patent Application Publication
(10) Pub. No.: US 2026/0225275 A1
(43) Pub. Date: Aug. 6, 2026

(54) WAX-COATED RAZOR BLADES

(71) Applicant: Planet Earth Razors AB, Stockholm (SE)

(72) Inventors: Mats DANIELSSON, Täby (SE); Mark RUTLAND, Sollentuna (SE); Denize SVENSSON, Stockholm (SE); Rabab AMJAD, Stockholm (SE)

(73) Assignee: Planet Earth Razors AB, Stockholm (SE)

(21) Appl. No.: 19/416,425

(22) Filed: Dec. 11, 2025

(30) Foreign Application Priority Data
Feb. 4, 2025 (SE) 2550102-4

(51) Int. Cl. B26B 21/60; B05B 1/14; B26B 21/22

(52) U.S. Cl. CPC B26B 21/60; B05B 1/14; B26B 21/222

(57) ABSTRACT

A method of coating a razor blade comprises coating surfaces of a cutting edge of the razor blade with an oxidized polyolefin wax and/or a partially oxidized polyolefin wax to form a PFAS-free coating comprising the oxidized polyolefin wax and/or the partially oxidized polyolefin wax. A razor blade comprising such a PFAS-free coating comprising the oxidized polyolefin wax and/or the partially oxidized polyolefin wax is also described.

### TECHNICAL FIELD

The present invention generally relates to razor blades for shaving, and in particular to such razor blades comprising a PFAS-free coating comprising an oxidized polyolefin wax and/or a partially oxidized polyolefin wax and methods of producing such razor blades.

### BACKGROUND

There is a vast range of razors for shaving, but these can broadly be classified into manual razors or electric razors. Manual razors employ a razor blade or a razor cartridge comprising one or multiple razor blades fixed or pivotally attached to a handle. The shaving action is achieved by the user manipulating the razor so as to move the razor blade(s) across the skin. The razor blade(s) thereby come(s) into contact with the skin and cut(s) the hair.

Today, the surfaces of the cutting edges of razor blades are coated to improve the shaving effectiveness of the razor blades. In particular, the coating decreases the pull to cut hair, i.e., decreases the force required to cut the hair and thereby improves the ease and smoothness of shaving. Hair proteins, in particular keratin, tend to adhere to the metal material of the razor blade if uncoated. This causes a pulling at the hair follicle during shaving. The coating reduces this adherence between razor blades and hair proteins. The most common coatings of razor blades today are obtained using per- and polyfluoroalkyl substance (PFAS) materials, including polytetrafluoroethylene (PTFE), often known by a proprietary name as TEFLON®. However, PFAS is environmentally harmful and will possibly be banned in the EU.

There is therefore a need for razor blades having a PFAS-free coating that decreases the force required to cut hair and thereby improve the ease and smoothness of shaving.

### SUMMARY

It is a general objective to provide a PFAS-free coating for razor blades.

It is a particular objective to provide a PFAS-free coating that allows for an easy and smooth shaving experience.

These and other objectives are met by embodiments of the present invention.

The present invention is defined in the independent claims. Further embodiments of the invention are defined in the dependent claims.

An aspect of the invention relates to a method of coating a razor blade. The method comprises coating surfaces of a cutting edge of the razor blade with an oxidized polyolefin wax and/or a partially oxidized polyolefin wax to form a PFAS-free coating comprising the oxidized polyolefin wax and/or the partially oxidized polyolefin wax.

Another aspect of the invention relates to a razor blade comprising a cutting edge comprising a PFAS-free coating comprising an oxidized polyolefin wax and/or a partially oxidized polyolefin wax on surfaces of the cutting edge.

The present invention provides an environmentally more friendly coating of razor blades than PFAS and PTFE by providing a PFAS-free coating comprising an oxidized polyolefin wax and/or a partially oxidized polyolefin wax. The wax coating significantly reduces the cutting force of the razor blade, thereby allowing for an easy and smooth shaving experience.

### BRIEF DESCRIPTION OF THE DRAWINGS

The embodiments, together with further objects and advantages thereof, may best be understood by making reference to the following description taken together with the accompanying drawings, in which:

FIGS. 1A and 1B illustrate different views of a razor comprising a handle and a razor cartridge according to an embodiment.

FIGS. 2A and 2B illustrate perspective views of an assembled razor cartridge as seen from above (2A) and below (2B).

FIGS. 3A to 3C illustrate a razor blade in a front view (3A) and in a side view (3B) and a razor blade assembly (3C) comprising a razor blade (20).

FIG. 4 is a flow chart illustrating a method of coating a razor blade according to an embodiment.

FIG. 5 is a flow chart illustrating additional, optional steps of the method in FIG. 4 according to various embodiments.

FIG. 6 is a flow chart illustrating various embodiment of step S1 in FIG. 4.

FIG. 7 is a flow chart illustrating various embodiment of step S1 in FIG. 4.

### DETAILED DESCRIPTION

The present invention generally relates to razor blades for shaving, and in particular to such razor blades comprising a PFAS-free coating comprising an oxidized polyolefin wax and/or a partially oxidized polyolefin wax and methods of producing such razor blades.

In the art, a per- and polyfluoroalkyl substance (PFAS) material coating, such as a polytetrafluoroethylene (PTFE) (TEFLON®) coating, is often applied to at least the surfaces of the cutting edges of razor blades to improve the shaving effectiveness of the razor blades. In particular, the PFAS coating decreases the pull to cut hair, i.e., decreases the force required to cut the hair, and thereby improves the ease and smoothness of shaving. Hair proteins, in particular keratin, tend to adhere to the material of the razor blade, such as stainless steel, if uncoated. This causes a pulling at the hair follicle during shaving. The PFAS coating reduces this adherence between razor blades and the hair proteins.

There is, however, a trend to move away from PFAS materials, including TEFLON®, due to environmental concerns. PTFE and related PFAS material do not break down easily in the environment so they can accumulate in soil, water and living organisms, leading to long-term environment contamination. Further, disposal of PTFE or PFAS products can be problematic since, when incinerated, they can release toxic fumes, including fluorinated compounds, which contribute to air pollution.

There is therefore a need for PFAS-free coatings for razor blades used for shaving and where the PFAS-free coatings decrease the cutting force required to cut hair. In particular, there is a need for such PFAS-free coatings made of more environmentally friendly materials than PFAS materials.

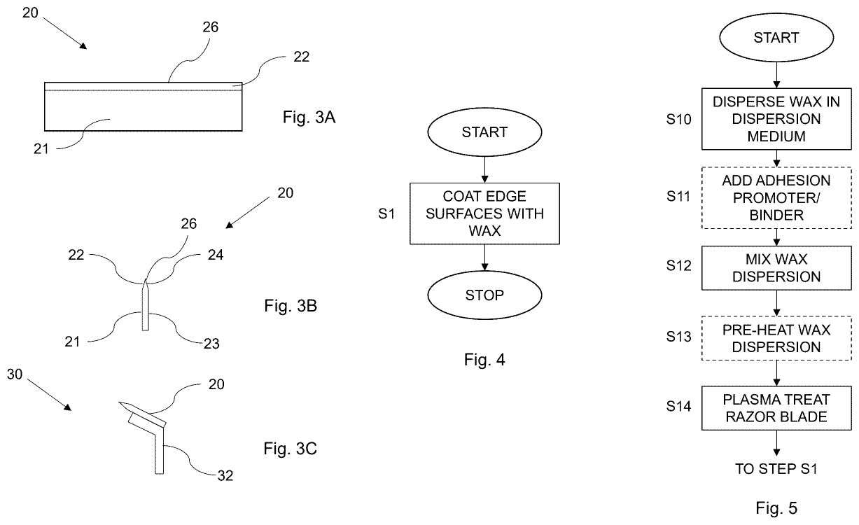

An aspect of the invention relates to a method of coating a razor blade 20, see FIGS. 3A, 3B and 4. The method comprising coating surfaces 22, 24 of a cutting edge 26 of a razor blade 20 with an oxidized polyolefin wax and/or a partially oxidized polyolefin wax to form a PFAS-free coating comprising the oxidized polyolefin wax and/or the partially oxidized polyolefin wax.

The present invention thereby uses a wax coating, and in more detail a coating of an oxidized polyolefin wax and/or a partially oxidized polyolefin wax, that is applied to at least the surfaces 22, 24 of the cutting edge 26 the razor blade 20 rather than PFAS or PTFE, i.e., TEFLON®. Accordingly, the wax coating as obtained by the method shown in FIG. 4 is a PFAS-free coating.

Experimental data as presented herein shows that such a PFAS-free wax coating can significantly reduce the cutting force of the razor blade 20 as compared to an uncoated razor blade 20. In particular, the cutting force of razor blades 20 coated with the PFAS-free wax coating can be as low as a third, or even lower, of the cutting force of an uncoated razor blade 20.

It is generally sufficient, and also preferred, if merely the surfaces 22, 24 of the cutting edge 26 of the razor blade 20 is coated with the oxidized polyolefin wax and/or the partially oxidized polyolefin wax. The embodiments are, however, not limited thereto. Thus, also larger parts of the surfaces 21, 23 of the razor blade 20 could be coated with the oxidized polyolefin wax and/or the partially oxidized polyolefin wax.

In an embodiment, the method comprises an additional step of cleaning the surfaces 22, 24 of at least the cutting edge 26. In a preferred embodiment, such a cleaning is performed by plasma treatment as shown by step S14 in FIG. 5.

Surfaces 22, 24 of the razor blade 20, and in particular of the cutting edge 26, are preferably cleaned to remove any contaminations or debris that may otherwise interfere with the adhesion of the oxidized polyolefin wax and/or the partially oxidized polyolefin wax to the surfaces 22, 24. Examples of such cleaning methods include, in addition to plasma treatment, oxygen plasma treatment, UV-ozone treatment, a treatment with an acidic (pH<7, typically pH 1-5, or even lower, such as pH 1-3) solution, a basic (pH>7, typically pH 10-14, or even higher, such as pH 12-14) solution, or a detergent, such as a surfactant detergent. The cleaning step may also combine any of the above-mentioned cleaning methods, such as combining plasma treatment with any of treatment with acidic solution, basic solution and/or detergent. Experimental data as present herein indicates that plasma treatment is generally sufficient to achieve a clean surface, to which the oxidized polyolefin wax and/or the partially oxidized polyolefin wax can be applied in step S1 of FIG. 4. Thus, plasma treatment is a preferred cleaning method. In fact, combining plasma treatment with another cleaning method, such as treatment with acidic or basic solution, did not improve the adhesion of the oxidized polyolefin wax and/or the partially oxidized polyolefin wax to the cleaned surfaces 22, 24 of the razor blade 20 and did not improve, i.e., lower, the chopping force of the razor blades 20.

An advantage of plasma treatment as cleaning method is that the plasma treatment not only removes any contamination and debris from the surfaces 22, 24 of the razor blade 20 but also activates the surfaces 22, 24, which may promote adhesion of the oxidized polyolefin wax and/or the partially oxidized polyolefin wax to the razor blade 20.

Further, the cleaning has the additionally benefit of improving the adhesion of a binder and/or adhesion promoter if such a binder and/or adhesion promoter is used between the surfaces 22, 24 of the razor blade 20 and the oxidized polyolefin wax and/or the partially oxidized polyolefin wax.

In an embodiment, the method comprises an additional step S10 as shown in FIG. 5. This step S10 comprises dispersing the oxidized polyolefin wax and/or the partially oxidized polyolefin wax in a dispersion medium to form a dispersion comprising the oxidized polyolefin wax and/or the partially oxidized polyolefin wax.

In an embodiment, the dispersion medium is selected from the group consisting of water and an alcohol. Illustrative, but preferred, examples of alcohols that could be used as dispersion medium for the oxidized polyolefin wax and/or the partially oxidized polyolefin wax include C1-C4 alcohols, a glycol and a glycol ether. Examples of C1-C4 alcohols include methanol, ethanol, a propanol, such as 1-propanol or 2-propanol, or a butanol, such as n-butanol, isobutanol, sec-butanol or tert-butanol. In a preferred embodiment, the C1-C4 alcohol is selected from the group consisting of methanol and ethanol, preferably ethanol. Glycol includes various aliphatic diols, in particular C2-C4 aliphatic diols, such as ethylene glycol (1,2-ethanediol), propylene glycol (1,2-propanediol), or butylene glycol, such as 1,3-butanediol or 1,4-butanediol. Illustrative, but non-limiting, examples of glycol ethers include 2-methoxyenthanol, 2-ethoxyethanol, 1-methoxy-2-propanol, 1-ethoxy-2-propanol, and 2-butoxyethanol (butyl glycol).

In a preferred embodiment, the dispersion medium is selected from the group consisting of water, ethanol and butyl glycol, preferably selected from the group consisting of water and butyl glycol. In an embodiment, the dispersion medium is water. In another embodiment, the dispersion medium is butyl glycol.

In an embodiment, the oxidized polyolefin wax and/or the partially oxidized polyolefin wax is dispersed in the dispersion medium in step S10 to form a dispersion comprising the oxidized polyolefin wax and/or the partially oxidized polyolefin wax at a concentration selected within an interval of from 0.01 up to 5% by weight, preferably up to 4% by weight, more preferably up to 3% by weight, and most preferably up to 2% by weight. In a preferred embodiment, the dispersion comprises the oxidized polyolefin wax and/or the partially oxidized polyolefin wax at a concentration selected within an interval of from 0.025 up to 1.5% by weight, preferably selected within an interval of from 0.05 up to 1% by weight, more preferably selected within an interval of from 0.1 up to 1% by weight, and most preferably selected within an interval of from 0.1 up to 0.75% by weight, such as from 0.1 up to 0.5% by weight, or from 0.1 up to 0.25% by weight. In other embodiments, the dispersion comprises the oxidized polyolefin wax and/or the partially oxidized polyolefin wax at a concentration selected within an interval of from 0.25 up to 0.75% by weight. In a particular embodiment, the dispersion comprises the oxidized polyolefin wax and/or the partially oxidized polyolefin wax at a concentration of about 0.5% by weight.

Experimental data as presented herein indicates that the chopping force of the coated razor blade 20 is generally increased if using a lower or higher concentration of the oxidized polyolefin wax and/or the partially oxidized polyolefin wax than the above-listed preferred intervals.

Reference to an interval herein, i.e., from X up to Y, includes the full range from X to Y including the end points of the interval, i.e., X and Y, unless otherwise specified.

In these embodiments, step S1 in FIG. 4 comprises coating the surfaces 22, 24 of the cutting edge 26 with the dispersion comprising the oxidized polyolefin wax and/or the partially oxidized polyolefin wax.

In an embodiment, the method also comprises the optional step S11, which comprises adding a binder and/or an adhesion promoter to the dispersion medium. In such a case, the dispersion comprises the oxidized polyolefin wax and/or the partially oxidized polyolefinwax and the binder and/or the adhesion promoter dispersed in the dispersion medium.

In an embodiment, the binder and/or adhesion promoter is added to the dispersion medium in step S11 at a weight ratio of oxidized polyolefin wax and/or the partially oxidized polyolefin wax:binder and/or adhesion promoter selected within an interval of from 1:0.1 up to 1:20. In a preferred embodiment, the weight ratio of oxidized polyolefin wax and/or the partially oxidized polyolefin wax:binder and/or adhesion promoter is selected within an interval of from 1:0.5 up to 1:15, preferably selected within an interval of from 1:1 up to 1:10.

In an embodiment, the binder is selected from the group consisting of a siloxane binder, a silane binder, a polymeric binder, and any combination thereof.

In an embodiment, the polymeric binder is selected from the group consisting of an acrylic binder, a polyurethane binder, and any combination thereof.

Examples of an acrylic binder include acrylic copolymers, such as anionic acrylic copolymers and more preferably alkylphenol ethoxylate (APEO) and formaldehyde free, anionic acrylic copolymers, such marked by CH-Polymers. Illustrative examples of such acrylic binders include CHP 550, CHP 555, CHP 556, CHP 559 and CHP 570, in particular CHP 555 or CHP 570, available from CH-Polymers.

In an embodiment, the adhesion promoter is selected from the group consisting of a siloxane adhesion promoter, a silane adhesion promoter, and any combination thereof.

Examples of silane binders and/or adhesion promoters include aminoalkyl silanes, such as 3-aminopropyltriethoxysilane, marketed as BRB Silanil® 581 or 919 by BRV International BV, 3-aminopropyltrimethoxysilane, marked as BRV Silanil® 138 by BRV International BV, N-(2-aminoethyl)-3-aminopropyl-trimethoxysilane, marked as BRB Silanil® 176 by BRV International BV, N-(2-aminoethyl)-3-aminopropyl-methyldimethoxysilane, marked as BRB Silanil® 307 by BRV International BV, N-(2-aminoethyl)-3-aminopropyl-triethoxysilane, marked as BRB Silanil® 505 by BRV International BV, preferably 3-aminopropyltriethoxysilane. The silanes may be partially hydrolysed and/or (partially) oligomerized and/or (partially) polymerized.

Examples of siloxane binders and/or adhesion promoters include polyether-modified siloxane adhesion promoters, such as BYK®-349 by BYK Additives.

In an embodiment, the method also comprises S12 as shown in FIG. 5, which comprises mixing the oxidized polyolefin wax and/or the partially oxidized polyolefin wax and the optional binder and/or optional adhesion promoter in the dispersion medium. In an embodiment, the mixing in step S12 is preferably performed for at least 5 s to form the dispersion comprising the oxidized polyolefin wax and/or the partially oxidized polyolefin wax and optionally the binder and/or the adhesion promoter. In a preferred embodiment, the mixing in step S12 is performed for at least 10 s, at least 30 s, at least 1 min, at least 5 min, at least 10 min, preferably at least 15 min, and more preferably at least 30 min. The mixing in step S12 could alternatively take place in situ, e.g., inside a spray gun used to spray coat the surfaces 22, 24 of the cutting edge 20 of the razor 20 as will be further described herein in connection with step S30 in FIG. 7. In such a case, even shorter mixing durations than 5 s are possible.

Examples of such mixing in step S12 include ultrasonication, high-shear mixing, and homogenization. A currently preferred embodiment is ultrasonication.

In an embodiment, the dispersion comprising the oxidized polyolefin wax and/or the partially oxidized polyolefin wax and optionally the binder and/or the adhesion promoter is heated in step S13. In such a case, the dispersion is preferably heated to a temperature above the glass transition temperature of the oxidized polyolefin wax and/or the partially oxidized polyolefin wax but below the melting point of the oxidized polyolefin wax and/or the partially oxidized polyolefin wax.

In a particular embodiment, the dispersion is heated to a temperature selected within an interval of from up to 95° C., preferably selected within an interval of from 50 up to 95° C., and more preferably about 90° C. These preferred temperatures are, in particular, suitable when the dispersion medium is water, i.e., the heating is preferably done up to a temperature that is below the boiling temperature of water. If another dispersion medium than water is used the preferred heating temperature is preferably selected to be below the boiling point of that dispersion medium. For instance, if butyl glycol is used as dispersion medium then the dispersion could be heated to higher temperatures than the above presented ranges since butyl glycol has a boiling point of around 170° C. Hence, in a general embodiment, the dispersion is heated to a temperature that is below the boiling point of the dispersion medium.

Any heating of the dispersion in step S13 is performed at a temperature below the boiling point of the dispersion medium.

Experimental data as presented herein shows that many dispersions benefit from pre-heating, in particular to a temperature equal to or above 50° C., such as about 90° C., in particular when the dispersion medium is water. However, for several dispersions no heat treatment is needed, meaning that keeping the dispersion at room temperature, i.e., 20-23.5° C., still provides PFAS-free coatings with low chopping force.

Instead of, or as an alternative to, pre-heating the dispersion, the razor blade 20 could be pre-heated. In such a case, the razor blade 20 could generally be heated to higher temperatures than the above-described preferred temperature ranges for pre-heating the dispersion. As an example, the razor blade could be pre-heated to a temperature of at least 100° C., preferably at least 200° C., more preferably at least 300° C., and most preferably at least 400° C. In an embodiment, step S13 comprises pre-heating the razor blade to a temperature of at least 100° C., preferably at least 200° C., more preferably at least 300° C., and most preferably at least 400° C.

In FIG. 5, the plasma treatment in step S14 has been shown as following step S13. The embodiments are, however, not limited thereto. Step S14 could be performed prior to step S10, following step S13 or indeed between any of the steps S10-S13 or at least partly in parallel with any of the steps S10-S13.

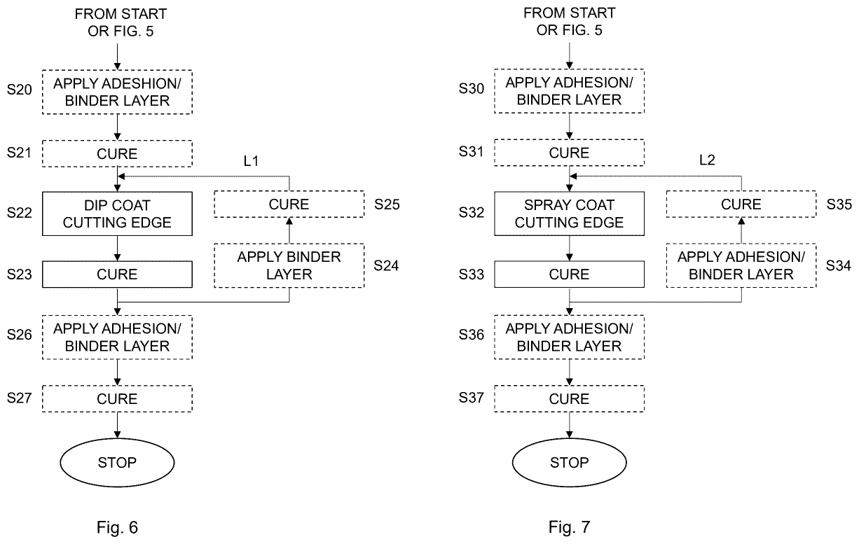

In an embodiment, the method also comprises, see FIGS. 6 and 7, coating S20, S30 the surfaces 22, 24 of the cutting edge 26 with a binder and/or adhesion dispersion comprising a binder and/or an adhesion promoter to form adhesion—and/or binder-coated surfaces 22, 24 of the cutting edge 26. In this embodiment, step S1 of FIG. 4 comprises coating S1 the adhesion—and/or binder-coated surfaces 22, 24 of the cutting edge 26 with the dispersion comprising the oxidized polyolefin wax and/or the partially oxidized polyolefin wax.

In this embodiment, the surfaces 22, 24 of the cutting edge 26 are first coated with an adhesion promoter and/or binder to form an adhesion promoter and/or binder layer. The oxidized polyolefin wax and/or the partially oxidized polyolefin wax is then, in this embodiment, applied to or coated onto the adhesion promoter and/or binder layer.

FIG. 6 is a flow chart illustrating an embodiment of the coating step S1 in FIG. 4. In this embodiment, the method starts in step S22 or continues from FIG. 5. Step S22 comprises dip coating the surfaces 22, 24 of the cutting edge 26 by dipping the cutting edge 26 of the razor blade 20 in the dispersion comprising the oxidized polyolefin wax and/or the partially oxidized polyolefin wax.

In an embodiment, the method also comprises a following step S23, which comprises curing the dip coated cutting edge 26.

In an embodiment, the dip coated cutting edge 26 is cured at a temperature selected within an interval of from 80° C. up to 450° C. in step S21, preferably from 100° C. up to 450° C., and more preferably from 150° C. up to 450° C. in step S23. In a particular embodiment, the curing of step S21 is performed at a temperature selected within an interval of from 180° C. up to 400° C., preferably selected within an interval of from 200° C. up to 250° C., and more preferably about 220° C.

In an embodiment, the dip coated cutting edge 26 is cured in step S23 for a period of time selected within an interval of from 1 s up to up to 30 min. In a particular embodiment, the curing of step S23 is performed for a period of time selected within an interval of from 10 s up to 25 min, preferably selected within an interval of from 1 min up to 20 min, more preferably selected within an interval of from 2 min up to 15 min, most preferably selected within an interval of from 5 up to 10 min, such as about 8 min.

Generally, a shorter curing period could be used in step S23 when using a higher curing temperature. An example of a suitable curing protocol is a curing at a temperature of about 220° C. for about 8 min.

The cured and dip coated cutting edge 26 is optionally cooled following curing to room temperature, i.e., to 20-23.5° C.

The method of steps S22 and S23 applies one layer of the oxidized polyolefin wax and/or the partially oxidized polyolefin wax to the surfaces 22, 24 of the cutting edge 26 of the razor blade 20. Experimental data as presented herein shows that the chopping force of the razor blade 20 can be lowered by applying multiple, i.e., at least two, layers of the oxidized polyolefin wax and/or the partially oxidized polyolefin wax to the surfaces 22, 24 of the cutting edge 26. Thus, in a preferred embodiment, steps S22 and S23 in FIG. 6 are repeated at least once, which is schematically shown by the loop L1 in FIG. 6.

Thus, in an embodiment, the method comprises repeating dipping the cutting edge 26 in step S22, curing the dip coated cutting edge 26 in step S23 and optionally cooling the cured and dip coated cutting edge at least once. In an embodiment, the optional cooling step is omitted between a curing step S23 and a following dip coating step S22 and is instead only performed following the last curing step S23.

In an embodiment, the loop of steps S22 and S23 is performed at least twice, at least three times, or even more, such as at least four times. In a preferred embodiment, the loop L1 is performed once or twice times to thereby obtain a more complete single layer, or two or three layers of the oxidized polyolefin wax and/or the partially oxidized polyolefin wax to the surfaces 22, 24 of the cutting edge 26. In an embodiment, the loop L1 is performed once to obtain a more complete layer or two layers of the oxidized polyolefin wax and/or the partially oxidized polyolefin wax to the surfaces 22, 24 of the cutting edge 26. In another embodiment, the loop L1 is performed twice to obtain a more complete layer or three layers of the oxidized polyolefin wax and/or the partially oxidized polyolefin wax to the surfaces 22, 24 of the cutting edge 26.

In an embodiment, the method also comprises applying a binder and/or an adhesion promoter as indicated by steps S20, S24 and S26 in FIG. 6 to thereby obtain at least one binder and/or adhesion layer on the surfaces 22, 24 of the cutting edge 26 of the razor blade 20.

In such a case, the method further comprises spray coating, in step S20, S24 and/or S26, the surfaces 22, 24 of the cutting edge 26 with a spray gun loaded with a binder and/or adhesion dispersion comprising a binder and/or an adhesion promoter, or dipping, in step S20, S24 and/or S26, the cutting edge 26 of the razor blade 20 in the binder and/or adhesion dispersion. In an embodiment, the method also comprises curing, in step S21, S25 and/or S27, the spray-coated or dip-coated cutting edge 26.

In an embodiment, spray coating the surfaces 22, 24 of the cutting edge 26 with the spray gun loaded with the binder and/or adhesion dispersion or dipping the cutting edge 26 of the razor blade 20 in the binder and/or adhesion dispersion in step S24 is performed in between curing the dip coated cutting edge in step S23 and dipping the cutting edge 26 of the razor blade 20 in the dispersion comprising the oxidized polyolefin wax and/or the partially oxidized polyolefin wax in step S22. Thus, in such an embodiment, the application of the binder and/or adhesion layer is performed in step S24, i.e., in the loop L1. This means that the binder and/or adhesion layer will be applied in between two layers of the oxidized polyolefin wax and/or the partially oxidized polyolefin wax. In such an embodiment, the optional curing step S25 is performed following application of the binder and/or adhesion layer, i.e., by spray coating or dip coating with the binder and/or adhesion dispersion in step S24, but prior to dip coating with the dispersion comprising the oxidized polyolefin wax and/or the partially oxidized polyolefin wax in step S22.

As an example, the surfaces 22, 24 of the cutting edge 26 of the razor blade 20 comprises an inner layer of the oxidized polyolefin wax and/or the partially oxidized polyolefin wax, an intermediate binder and/or adhesion layer, and an outer layer of the oxidized polyolefin wax and/or the partially oxidized polyolefin wax in the case of performing steps S22 and S23 twice. If the razor blade 20 comprise more than two layers of the oxidized polyolefin wax and/or the partially oxidized polyolefin wax, such as three layers of the oxidized polyolefin wax and/or the partially oxidized polyolefin wax, then the binder and/or adhesion layer could be present intermediate the innermost and middle oxidized polyolefin wax and/or the partially oxidized polyolefin wax layers and/or present intermediate the middle and outermost oxidized polyolefin wax and/or the partially oxidized polyolefin wax layers. Thus, steps S24 and S25 could be performed each time steps S22 and S23 are repeated or only once, thereby omitting steps S24 and S25 once in the loop L1.

In another embodiment, spray coating the surfaces 22, 24 of the cutting edge 26 with the spray gun loaded with the binder and/or adhesion dispersion or dipping the cutting edge 26 of the razor blade 20 in the binder and/or adhesion dispersion is performed after curing the dip coated cutting edge 26 in step S23 following the last dipping the cutting edge 26 of the razor blade 20 in the dispersion comprising the oxidized polyolefin wax and/or the partially oxidized polyolefin wax in step S22. Thus, in such an embodiment, the application of the binder and/or adhesion layer is performed in step S26, i.e., after application of the multiple layers of the oxidized polyolefin wax and/or the partially oxidized polyolefin wax and the last curing in step S23. This means that the binder and/or adhesion layer is applied on the one or multiple layers of the oxidized polyolefin wax and/or the partially oxidized polyolefin wax. In such an embodiment, the optional curing step S27 is performed following application of the binder and/or adhesion layer, i.e., by spray coating or dip coating with the binder and/or adhesion dispersion in step S24.

In a further embodiment, spray coating the surfaces 22, 24 of the cutting edge 26 with the spray gun loaded with the binder and/or adhesion dispersion or dipping the cutting edge 26 of the razor blade 20 in the binder and/or adhesion dispersion is performed prior to dip coating the cutting edge 26 of the razor blade 20 in the dispersion comprising the oxidized polyolefin wax and/or the partially oxidized polyolefin wax in step S22. Thus, in such an embodiment, the application of the binder and/or adhesion layer is performed in step S20, i.e., prior to application of the one or multiple layers of the oxidized polyolefin wax and/or the partially oxidized polyolefin wax. This means that the one or multiple layers of the oxidized polyolefin wax and/or the partially oxidized polyolefin wax are applied onto the binder and/or adhesion layer. In such an embodiment, the optional curing step S21 is performed following application of the binder layer, i.e., by spray coating or dip coating with the binder and/or adhesion dispersion in step S20.

The above-described embodiments can be combined. For instance, application of the binder and/or adhesion layer in step S20 prior to the layers of the oxidized polyolefin wax and/or the partially oxidized polyolefin wax and application of the binder and/or adhesion layer in step S24 in between two layers of the oxidized polyolefin wax and/or the partially oxidized polyolefin wax, or application of the binder and/or adhesion layer in step S20 prior to the layers of the oxidized polyolefin wax and/or the partially oxidized polyolefin wax and application of the binder and/or adhesion layer in step S26 as an outermost layer in the stack of the oxidized polyolefin wax and/or the partially oxidized polyolefin wax and binder and/or adhesion layers. Alternatively, application of the binder and/or adhesion layer in step S24 in between two layers of the oxidized polyolefin wax and/or the partially oxidized polyolefin wax is combined with application of the binder and/or adhesion layer in step S26 as an outermost layer in the stack of the oxidized polyolefin wax and/or the partially oxidized polyolefin wax and binder and/or adhesion layers. In a further alternative, application of the binder and/or adhesion layer in step S20 prior to the layers of the oxidized polyolefin wax and/or the partially oxidized polyolefin wax and application of the binder and/or adhesion layer in step S24 in between two layers of the oxidized polyolefin wax and/or the partially oxidized polyolefin wax are combined with application of the binder and/or adhesion layer in step S26 as an outermost layer in the stack of the oxidized polyolefin wax and/or the partially oxidized polyolefin wax and binder and/or adhesion layers.

For instance and with an example of dual layers of the oxidized polyolefin wax and/or the partially oxidized polyolefin wax, the surfaces 22, 24 of the cutting edge 26 of the razor blade 20 could be coated with binder and/or adhesion layer, wax layer and wax layer; wax layer, binder and/or adhesion layer and wax layer; wax layer, wax layer and binder and/or adhesion layer; binder and/or adhesion layer, wax layer, binder and/or adhesion layer and wax layer; binder and/or adhesion layer, wax layer, wax layer and binder and/or adhesion layer; wax layer, binder and/or adhesion layer, wax layer and binder and/or adhesion layer; or binder and/or adhesion layer, wax layer, binder layer, wax layer and binder and/or adhesion layer.

Curing could be applied following each dip coating or spray coating step, i.e., both following dip coating in or spray coating the dispersion comprising the oxidized polyolefin wax and/or the partially oxidized polyolefin wax and dip coating in or spray coating the binder and/or adhesion dispersion. Alternatively, curing could be omitted following dip coating in or spray coating the binder and/or adhesion dispersion and then only performed following dip coating in or spray coating the dispersion comprising the oxidized polyolefin wax and/or the partially oxidized polyolefin wax, or vice versa.

As an illustrative example, the razor blade 20, preferably following plasma treatment in step S14 in FIG. 5, could be subject to dip coating in the binder and/or adhesion dispersion followed by, after an optional “resting” period of from 0 min up to 60 min, such as from 5 min up to 45 min, preferably about 30 min, dip coating in the dispersion comprising the oxidized polyolefin wax and/or the partially oxidized polyolefin wax, curing, a second dip coating in the dispersion comprising the oxidized polyolefin wax and/or the partially oxidized polyolefin wax, and then a second curing.

Experimental data as presented herein shows that it is generally preferred to have an inner binder and/or adhesion layer and two wax layers, an intermediate binder and/or adhesion layer between two wax layers or having an outermost binder and/or adhesion layer on the multiple wax layers.

The curing in step S21 following application of the binder and/or adhesion layer in step S20, the curing in step S25 following application of the binder and/or adhesion layer in step S24 and the curing in step S27 following application of the binder and/or adhesion layer in step S26 are preferably performed as described in the foregoing in connection with step S23. In other words, the curing in step S21, S25 and/or S27 is/are preferably performed at a temperature selected within an interval of from 100° C. up to 450° C., such as from 150° C. up to 450° C., preferably selected within an interval of from 180° C. up to 400° C., more preferably selected within an interval of from 200° C. up to 250° C., and most preferably about 220° C. Further, the curing in step S21, S25 and/or S27 is/are preferably performed for a period of time selected within an interval of from 1 s up to up to 30 min, preferably selected within an interval of from 10 s up to 25 min, more preferably selected within an interval of from 1 min up to 20 min, even more preferably selected within an interval of from 2 min up to 15 min, most preferably selected within an interval of from up to 10 min, such as about 8 min.

The application of a binder and/or adhesion layer in step S20, S24 and/or S26 could be combined with, or used as an alternative to, adding a binder and/or an adhesion promoter to the dispersion medium in step S11.

The binder and/or adhesion dispersion used in the spray coating or dip coating in step S20, S24 and/or S26 comprises the binder and/or the adhesion promoter dispersed in a dispersion medium. The dispersion medium is preferably selected from the previously discussed dispersion media, i.e., is preferably selected from the group consisting of water and an alcohol, more preferably selected from the group consisting of water, a C1-C4 alcohol, a glycol and a glycol ether, even more preferably selected from the group consisting of water, ethanol and butyl glycol, and most preferably water.

The binder and/or the adhesion promoter is preferably dispersed in the dispersion medium at a concentration selected within an interval of from 0.01 up to 2% by weight, preferably selected within an interval of from 0.025 up to 1.5% by weight, such as preferably selected within an interval of from 0.05 up to 1% by weight, more preferably selected within an interval of from 0.1 up to 0.5% by weight, and most preferably about 0.25% by weight or within an interval of from 0.1 up to 0.25% by weight.

The binder is preferably selected among the binders discussed in the foregoing in connection with step S11 of FIG. 5.

The adhesion promoter is preferably selected among the adhesion promoters discussed in foregoing in connection with step S11 of FIG. 5.

In a particular embodiment, step S20, S24 and/or S26 comprises dipping the cutting edge 26 of the razor blade 20 in the binder and/or adhesion dispersion. Thus, in such an embodiment, a same application technique, i.e., dip coating, is used in step S20, S24 and/or S26 as in step S22.

In another particular embodiment, step S20, S24 and/or S26 comprises spray coating the cutting edge of the razor blade 20 with a spray gun loaded with a binder and/or adhesion dispersion comprising a binder and/or an adhesion promoter. Thus, in such an embodiment, a different application technique is used in step S20, S24 and/or S26 as in step S22.

FIG. 7 is a flow chart illustrating another embodiment the coating step S1 in FIG. 4. In this embodiment, the method starts in step S32 or continues from FIG. 5. Step S32 comprises spray coating the surfaces 22, 24 of the cutting edge 26 with a spray gun loaded with the dispersion comprising the oxidized polyolefin wax and/or the partially oxidized polyolefin wax.

Spray coating in step S32 thereby applies the dispersion as a spray onto the surfaces 22, 24 of the cutting edge 26. The dispersion is emitted from the spray gun as a mist of droplets of the dispersion comprising the oxidized polyolefin wax and/or the partially oxidized polyolefin wax. The oxidized polyolefin wax and/or the partially oxidized polyolefin wax is thereby deposited onto the surfaces 22, 24 of the cutting edge 26 of the razor blade 20.

In an embodiment, step S32 comprises spray coating the surfaces 22, 24 of the cutting edge 26 with the spray gun loaded with the dispersion comprising the oxidized polyolefin wax and/or the partially oxidized polyolefin wax and using a compressed gas to atomize the dispersion comprising the oxidized polyolefin wax and/or the partially oxidized polyolefin wax.

The compressed gas used by the spray gun to atomize the dispersion could be any gas or gas mixture compatible with the dispersion. Illustrative, but non-limiting, examples include compressed air, compressed carbon dioxide (CO₂), compressed nitrogen (N₂), or a compressed inert gas, such as compressed helium (He), compressed neon (Ne) or compressed argon (Ar).

The compressed gas has a pressure higher than ambient pressure (1 bar). In an embodiment, the compressed gas has a pressure equal to or above 1.5 bar, preferably equal to or above 2 bar, more preferably equal to or above 2.5 bar, and most preferably equal to or above 3 bar.

In an embodiment, step S32 comprises spray coating the surfaces 22, 24 of the cutting edge 26 with the spray gun loaded with the dispersion comprising the oxidized polyolefin wax and/or the partially oxidized polyolefin wax while providing a relative movement between the razor blade 20 and the spray gun.

In this embodiment, a relative movement between the razor blade 20 and the spray gun is provided while the spray gun is spraying the dispersion onto the surfaces 22, 24 of the cutting edge 26. Such a relative movement could be achieved by having the razor blade 20 stationary, such as in a razor blade holder, while moving the spray gun relative to the stationary razor blade 20. Alternatively, the spray gun could be kept stationary while spraying and the razor blade 20 is then moved relative to the stationary spray gun. It is also possible to move both the razor blade 20 and the spray gun during spraying the dispersion. In such a case, the razor blade 20 and the spray gun are preferably moved in opposite directions.

In an embodiment, step S32 comprises spray coating the surfaces 22, 24 of the cutting edge 26 with the spray gun loaded with the dispersion comprising the oxidized polyolefin wax and/or the partially oxidized polyolefin wax while moving the spray gun relative to the razor blade 20 in a first direction and in a second reciprocal direction, or vice versa.

Thus, in an embodiment, the spray gun is first moved relative to the stationary razor blade in a first direction while spraying the dispersion onto the surfaces 22, 24 of the cutting edge 26. The spray gun is then moved in a second reciprocal, i.e., opposite, direction while spraying the dispersion onto the surfaces 22, 24 of the cutting edge 26. Alternatively, the razor blade 20 is first moved relative to the stationary spray gun in a first direction while the spray gun sprays the dispersion onto the surfaces 22, 24 of the cutting edge 26. The razor blade 20 is then moved in a second reciprocal direction relative to the stationary spray gun while the spray gun sprays the dispersion onto the surfaces 22, 24 of the cutting edge 26.

In the above-described embodiments, it is generally preferred to keep the razor blade 20 stationary while moving the spray gun relative to the stationary razor blade 20.

In an embodiment, step S32 can be performed without any relative movement of the razor blade 20 and the spray gun. Such an embodiment is in particular possible if the spray gun has a sufficiently wide spray nozzle to spray the dispersion onto at least one of the surfaces 22, 24 of the cutting edge 26. For instance, a first surface 22 of the cutting edge 26 could be sprayed first and then the razor blade 20 is turned relative to the spray gun to spray a second surface 24 of the cutting edge 20. It is also possible to spray coat both surfaces 22, 24 of the cutting edge 26 without any turning of the razor blade 20. For instance, the spray gun could be arranged facing the cutting edge 26 of the razor blade 20, such as above the razor blade 20 in FIG. 3B but with the nozzle facing the cutting edge 26.

In an embodiment, the method also comprises a following step S33, which comprises curing the spray coated cutting edge 26. This step S33 is performed as step S23 and is therefore not further described herein. Thus, the preferred curing temperatures and curing time periods previously described in connection with step S23 in FIG. 6 also applies to step S33 in FIG. 7.

The embodiment as disclosed in FIG. 7 may also include an optional cooling step to cool the cured and spray coated cutting edge to room temperature, i.e., to 20-23.5° C., as described in the foregoing.

In an embodiment, the spray coating in step S32 and the curing in step S33 are preferably repeated at least once, which is schematically illustrated by the loop L2 in FIG. 7. In such an embodiment, multiple layers of the oxidized polyolefin wax and/or the partially oxidized polyolefin wax are provided onto the surfaces 22, 24 of the cutting edge 26 by spray coating. The various embodiments described in the connection with FIG. 6 in terms of performing steps S22 and S23 multiple times, as indicated by the loop L1 in FIG. 6, apply to the embodiment in FIG. 7. The only difference is then that the dispersion is applied by spray coating in step S32 rather than by dip coating as in step S22.

In an embodiment, the method also comprises application of one or more binder and/or adhesion layers in step S30, S34 and/or S36. These steps S30, S34 and S36 and the optional following curing steps S31, S35 and S37 are performed as described in the foregoing in connection with steps S20, S24 and S26 and the optional curing steps S21, S25 and S27 and thereby not described in more detail herein. Thus, step S30, S34 and/or S36 comprises spray coating the surfaces 22, 24 of the cutting edge 26 with a spray gun loaded with a binder and/or adhesion dispersion comprising a binder and/or adhesion promoter or dipping the cutting edge 26 of the razor blade 20 in the binder and/or adhesion dispersion.

In an embodiment, step S30, S34 and/or S36 comprises spray coating the surfaces 22, 24 of the cutting edge 26 with a spray gun loaded with a binder and/or adhesion dispersion comprising a binder and/or an adhesion promoter. In such an embodiment, spray coating is used both for application of the dispersion in step S32 and for the application of the binder and/or adhesion dispersion in step S30, S34 and/or S36.

In another embodiment, step S30, S34 and/or S36 comprises dip coating the surfaces 22, 24 of the cutting edge 26 in a binder and/or adhesion dispersion comprising a binder and/or an adhesion promoter.

Curing could be applied following each spray coating step, i.e., both following spray coating of the dispersion comprising the oxidized polyolefin wax and/or the partially oxidized polyolefin wax and spray coating of the binder and/or adhesion dispersion. Alternatively, curing could be omitted following spray coating of the binder and/or adhesion dispersion and then only performed following spray coating of the dispersion comprising the oxidized polyolefin wax and/or the partially oxidized polyolefin wax.

As an illustrative example, the razor blade 20, preferably following plasma treatment in step S14 in FIG. 5, could be spray coated with the binder and/or adhesion dispersion followed by, spray coating of the dispersion comprising the oxidized polyolefin wax and/or the partially oxidized polyolefin wax, curing, a second spray coating of the dispersion comprising the oxidized polyolefin wax and/or the partially oxidized polyolefin wax, and then a second curing.

The binder and/or adhesion dispersion, binder and/or adhesion promoter and dispersion medium for the binder and/or the adhesion promoter described in the foregoing in connection with FIG. 6 can also be used in the embodiment of FIG. 7.

Application of the binder and/or adhesion dispersion by spray coating in steps S30, S34 and/or S36 can be performed as described above in connection with step S32 in FIG. 7 but with the difference of using the binder and/or adhesion dispersion rather than the dispersion comprising the oxidized polyolefin wax and/or the partially oxidized polyolefin wax.

It is also possible to combine the embodiments shown in FIGS. 6 and 7 in the case of application of multiple layers of the oxidized polyolefin wax and/or the partially oxidized polyolefin wax. In such a case, at least one layer of oxidized polyolefin wax and/or the partially oxidized polyolefin wax is applied by dip coating in step S22 in FIG. 6 and at least one layer of oxidized polyolefin wax and/or the partially oxidized polyolefin wax is applied by spray coating in step S32 in FIG. 7. However, it is generally preferred to use the same coating protocol for all layers of the polyolefin or paraffin wax, i.e., all are applied by dip coating in step S22 or all are applied by spray coating in step S32.

The embodiments as shown in FIGS. 6 and 7 could apply multiple layers of the oxidized polyolefin wax and/or the partially oxidized polyolefin wax in step S22 or S32 by performing the loop L1 or L2 at least once. In such a case, the curing in step S23 or S33 following the second or additional layer of the oxidized polyolefin wax and/or the partially oxidized polyolefin wax preferably causes the multiple layer of the oxidized polyolefin wax and/or the partially oxidized polyolefin wax to integrate or fuse into one layer of the of the oxidized polyolefin wax and/or the partially oxidized polyolefin wax.

Polyolefin is a type of polymer with the general formula (CH₂CHR)ₙ. where R is an alkyl group.

In an embodiment, the oxidized polyolefin wax is selected from the group consisting of an oxidized polyethylene (OPE) wax and an oxidized polypropylene (OPP) wax. OPE waxes generally have a high melting point and excellent lubrication properties. Accordingly, OPE waxes are highly suitable for coating razor blades 20 to achieve a low cutting force when cutting hair during shaving and thereby thereby improves the ease and smoothness of shaving.

In a particular embodiment, the oxidized polyolefin wax is selected from the group consisting of an oxidized polyethylene (OPE) wax and an oxidized polypropylene (OPP) wax.

In a currently preferred embodiment, the oxidized polyolefin wax is an OPE wax, and preferably a non-ionic OPE wax.

In an embodiment, the partially oxidized polyolefin wax is selected from the group consisting of a partially oxidized polyethylene (POPE) wax and a partially oxidized polypropylene (POPP) wax.

In a currently preferred embodiment, the partially oxidized polyolefin wax is a POPE wax, and preferably a non-ionic POPE wax. There are key differences between polyolefin waxes, such as PE or PP waxes, and oxidized polyolefin waxes, such as OPE or OPP waxes in their chemical structure and functional properties. Experimental data as presented herein show that oxidized polyolefin waxes are superior to corresponding polyolefin waxes in application as surface coating of razor blades.

Polyolefin waxes, such as PE and PP waxes, are composed primarily of long-chain saturated hydrocarbons. They are non-polar and hydrophobic and have very few functional groups, i.e., no or few hydroxyl or carboxyl groups. Oxidized polyolefin waxes, such as OPE and OPP waxes are chemically modified to introduce polar functional groups, such as carboxylic groups (—COOH) and hydroxyl groups (—OH). This oxidation increases polarity and reactivity of the oxidized polyolefin waxes as compared to (non-oxidized) polyolefin waxes.

Partially oxidized polyolefin waxes, such as POPE and POPP waxes, have undergone limited or controlled oxidation resulting in a lower concentration of oxygen-containing groups, e.g., carboxylic and hydroxyl groups, as compared to oxidized polyolefin waxes, such as OPE and OPP waxes.

Acid Number (AN), also referred to as acid value, is a measure of the number of carboxylic groups in a chemical compound, such as a polyolefin wax. AN can be used as an indicator of the degree of oxidation of a polyolefin wax and is expressed in mg KOH/g. Generally, a non-oxidized polyolefin wax has an AN=0 mg KOH/g, a partially oxidized polyolefin wax has typically an AN within an interval of from 5 up to 15 mg KOH/g, and an oxidized polyolefin wax has typically an AN>15 mg KOH/g, such as within an interval of from 15 up to 30 mg KOH/g, or even higher.

The PFAS-free coating of the present technology comprises the oxidized polyolefin wax and/or the partially oxidized polyolefin wax.

In an embodiment, the PFAS-free coating comprises an oxidized polyolefin wax, such as an OPE wax or an OPP wax. In another embodiment, the PFAS-free coating comprises multiple oxidized polyolefin waxes, such as a mixture of two or more different OPE waxes, a mixture of two or more different OPP waxes, or a mixture of at least one OPE wax and at least one OPP wax.

In a further embodiment, the PFAS-free coating comprises a partially oxidized polyolefin wax, such as a POPE wax or a POPP wax. In another embodiment, the PFAS-free coating comprises multiple partially oxidized polyolefin waxes, such as a mixture of two or more different POPE waxes, a mixture of two or more different POPP waxes, or a mixture of at least one POPE wax and at least one POPP wax.

In yet another embodiment, the PFAS-free coating comprises at least one oxidized polyolefin wax and at least one partially oxidized wax, such as mixture of an OPE wax and a POPE wax, or a mixture of an OPP wax and a POPP wax.

In any of the above-described embodiments, the PFAS-free coating may additionally comprise at least one polyolefin wax, such as a PE wax and/or a PP wax, in addition to at least one oxidized polyolefin wax and/or at least one partially oxidized polyolefin wax. Thus, the PFAS-free coating may comprise a mixture of at least one oxidized polyolefin wax and at least one (non-oxidized) polyolefin wax, a mixture of at least one partially oxidized polyolefin wax and at least one (non-oxidized) polyolefin wax, or a mixture of at least one oxidized polyolefin wax, at least one partially oxidized polyolefin wax and at least one (non-oxidized) polyolefin wax.

The method of the invention as described in the foregoing in connection FIGS. 4-7 can be used not only for de novo coating of razor blades 20, i.e., coating of new razor blades 20. The method can alternatively, or in addition, be used to re-coat razor blades 20.

Razor blades 20 as such are most often not worn out when a consumer disposes a razor cartridge 10 comprising razor blades. This means that the razor blades 20 could be re-used several times rather than being disposed if they could be refurbished. A key step in such a refurbishment of the razor blades 20 is to replace the coating at the cutting edges 26 of the razor blades 20, which has been worn out during use. Hence, if a razor blade 20 is to be refurbished and re-used, the at least partly worn-out edge coating needs to be replaced. The method of the invention can be used to recoat the surfaces 22, 24 of the cutting edge 26 of a used razor blade 20. Thus, the invention enables refurbishment and re-use of razor blades 20.

Hence, in an embodiment, step S1 of FIG. 4 comprises recoating the surfaces 22, 24 of the cutting edge of a used razor blade 20 with the oxidized polyolefin wax and/or the partially oxidized polyolefin wax to form the PFAS-free coating comprising the oxidized polyolefin wax and/or the partially oxidized polyolefin wax.

In such an embodiment, the surfaces 22, 24 of the cutting edge 26 of the used razor blade 20 are first cleaned to remove any coating material or contaminants on the surfaces 22, 24 prior to recoating the surfaces 22, 24 of the cutting edge 26.

Such a cleaning of the surfaces 22, 24 to remove any previous coating material or contaminations could be performed as described previously herein in connection with step S14 in FIG. 5. Thus, the cleaning could involve one or more of plasma treatment, treatment with acidic solution, treatment with basic solution and treatment with detergent, such as a surface detergent. A single cleaning operation could be performed, such as plasma treatment, or treatment with acidic or basic solution or treatment with detergent, or multiple cleaning operations could be performed, such as starting with treatment with acidic and/or basic solution, and/or treatment with detergent, followed by plasma treatment.

Another aspect of the invention relates to a razor blade 20 comprising a cutting edge 26 comprising a PFAS-free coating comprising an oxidized polyolefin wax and/or a partially oxidized polyolefin wax on surfaces 22, 24 of the cutting edge 26.

In an embodiment, the cutting edge 26 comprises a PTFE-free coating comprising the oxidized polyolefin wax and/or the partially oxidized polyolefin wax on the surfaces 22, 24 of the cutting edge 26.

In an embodiment, the razor blade 20 is made of a metal or metal alloy. Illustrative, but non-limiting, examples of such metals and metal alloys include stainless steel, carbon steel, chromium, and titanium. In a preferred embodiment, the razor blade 20 is made of steel, in particular stainless steel.

The razor blade 20 could be an uncoated razor blade 20 or could have a surface coating under the PFAS-free coating comprising the oxidized polyolefin wax and/or the partially oxidized polyolefin wax.

In an embodiment, the razor blade 20 comprises a surface coating on the surfaces 22, 24 of the cutting edge 26. In such an embodiment, the PFAS-free coating comprising the oxidized polyolefin wax and/or the partially oxidized polyolefin wax is provided on the surface coating.

In a particular embodiment, the surface coating is a diamond-like carbon (DLC) coating, a chromium coating, a chromium nitride coating, a titanium diboride coating, and/or a tungsten carbide coating.

DLC is a class of amorphous carbon material that contains significant amount of sp³ hybridized carbon atoms. DLC coatings have properties that make them suitable as surface coatings on razor blades 20, in particular steel razor blades 20. These properties include high hardness, which helps maintaining the sharpness of the razor blade 20 for a longer period, low friction, which reduces friction and allows the razor blade 20 to glide more easily over the skin resulting in a smoother shave, high corrosion resistance, which protects the razor blade 20 from rust and extends its lifespan. Additionally, DLC is biocompatible, which means that it is safe for contact with the skin of the user and reduces the risk of irritation or allergic reactions.

DLC exists in different forms as it can be found in different crystalline polytypes, including cubic lattice and hexagonal lattice, which can be mixed at nanoscale. These DLC forms include hydrogenated amorphous carbon (a-C: H), hydrogen-free amorphous carbon (a-C), tetrahedral amorphous carbon (ta-C), and hydrogenated tetrahedral amorphous carbon (ta-C: H), in addition to various doped forms of DLC.

Tungsten carbide (WC) has several beneficial properties making it suitable as surface coating for razor blades 20. These include high hardness allowing it to maintain a sharp edge of the razor blade 20 for a longer period of time, high wear resistance that ensures that the razor blade 20 remains effective even after extensive use, corrosion resistance to protect the razor blade 20 from rust and other form of degradation. Tungsten carbide also has a fine grain size allowing for the creation of very sharp edges, which facilitates a close and smooth shave.

Chromium nitride is a hard, interstitial compound where nitrogen atoms occupy the interstices between chromium atoms. It may have the formula CrN or Cr₂N. It is highly corrosion resistant, has good temperature resistance and good wear resistance. It can be produced in thin films and thus is highly suitable as a coating for razor blades.

Thin chromium films have several beneficial properties including improved adhesion as they from a robust interface between the base material and any coatings applied above it. This property strengthens the adhesion of subsequent layers to the underlying surface. Chromium films further have good oxidation resistance. When exposed to air, chromium naturally develops a thin, stable oxide film. Accordingly, a chromium coating typically has a surface layer of chromium oxide, typically chromium (III) oxide (Cr₂O₃). This protective layer helps prevent oxidation of the substrate, increasing the durability and longevity of the overall coating system. Chromium films also form an effective diffusion barrier. A chromium layer blocks the passage of oxygen, moisture, and various metal ions between the substrate and later coatings. This barrier action protects sensitive materials or devices from contamination and chemical degradation. Chromium additionally achieves surface smoothing. Chromium coatings provide a uniform, smooth finish, creating an ideal surface for additional layers. This is essential when a defect-free, high-quality surface is required. Chromium is further compatible with many materials and deposition techniques. Methods such as sputtering, physical vapor deposition (PVD), and electroplating can all be used, making it easy to integrate into the manufacturing processes. A surface coating of chromium as used herein include a surface coating of chromium and chromium oxide.

Titanium diboride (TiB₂) is a ceramic material that can be used as a surface coating for razor blades due to its exceptional combination of properties. Its extremely high hardness and wear resistance help maintain a sharp cutting edge over prolonged use, while its low coefficient of friction ensures smooth shaving with reduced drag. TiB₂ also exhibits excellent chemical stability and corrosion resistance, making it ideal for environments exposed to water and shaving products. Additionally, the material can be deposited as a thin, uniform layer using techniques such as physical vapor deposition (PVD), preserving blade sharpness without adding bulk.

In the case of coating coated razor blades 20, such as DLC or WC coated razor blades 20, it may be beneficial to activate the surfaces of the coated razor blades 20 to enhance the adhesion of the oxidized polyolefin wax and/or the partially oxidized polyolefin wax onto the coated razor blades 20. An example of such a surface activation is the deposition of an adhesion layer onto the DLC or WC coating prior to coating the surfaces 22, 24 of the cutting edge 26 of the razor blade 20 with an oxidized polyolefin wax and/or a partially oxidized polyolefin wax. Illustrative, but non-limiting, examples of such adhesion layers include a chromium layer, a titanium layer, a nickel layer or platinum layer. Also, non-metallic surface treatments could be used to improve wax coating adhesion. Other examples of such a surface activation include a plasma treatment, heat treatment, or UV-ozone treatment.

In an embodiment, the oxidized polyolefin wax is selected from the group consisting of an OPE wax and an OPP wax.

In a preferred embodiment, the oxidized polyolefin wax is an OPE wax, and preferably a non-ionic OPE wax.

In an embodiment, the partially oxidized polyolefin wax is selected from the group consisting of a POPE wax and a POPP wax.

In a preferred embodiment, the partially oxidized polyolefin wax is a POPE wax, and preferably a non-ionic POPE wax.

In an embodiment, the oxidized polyolefin wax and/or the partially oxidized polyolefin wax comprises a binder and/or an adhesion promoter. In an embodiment, the weight ratio of oxidized polyolefin wax and/or the partially oxidized polyolefin wax:binder and/or adhesion promoter is selected within an interval of from 2:1 up to 1:10, preferably selected within an interval of from 1:0.1 up to 1:20, preferably selected within an interval of from 1:0.5 up to 1:15, more preferably selected within an interval of from 1:1 up to 1:10.

In an embodiment, the PFAS-free coating comprises an adhesion promoter and/or binder layer on the surfaces 22, 24 of the cutting edge 26. In this embodiment, the oxidized polyolefin wax and/or the partially oxidized polyolefin wax is provided on the adhesion promoter and/or binder layer.

In an embodiment, the PFAS-free coating comprises multiple layers of the oxidized polyolefin wax and/or the partially oxidized polyolefin wax on the surfaces of the cutting edge.

In an embodiment, the PFAS-free coating comprises at least one binder and/or adhesion layer comprising a binder and/or an adhesion promoter. In a particular embodiment, the at least one binder and/or adhesion layer is provided on the multiple layers of the polyolefin wax and/or in between two layers of the multiple layers of the oxidized polyolefin wax and/or the partially oxidized polyolefin wax and/or on the surfaces 22, 24 of the cutting edge 26, i.e., beneath the at least one layer of the oxidized polyolefin wax and/or the partially oxidized polyolefin wax.

In an embodiment, the razor blade 20 is obtainable, such as obtained, by the method of the present invention.

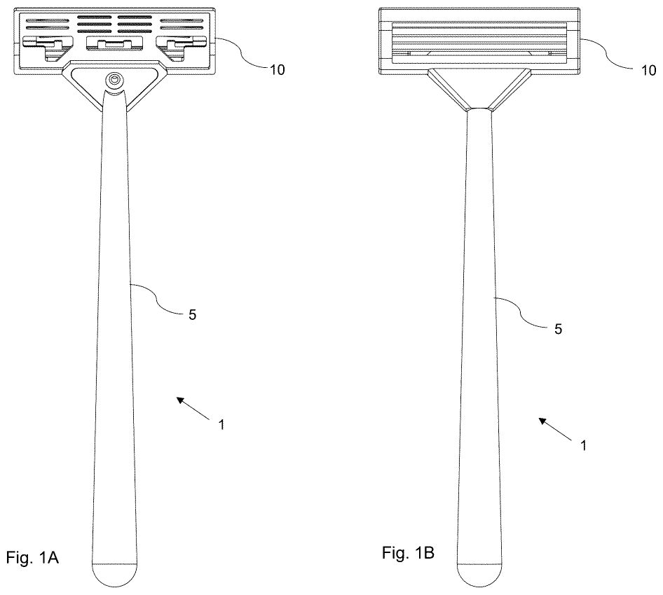

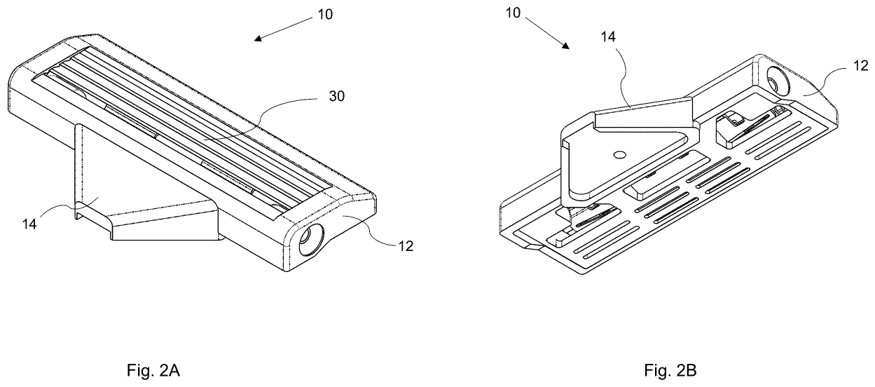

FIGS. 1A and 1B illustrates a razor 1 according to an embodiment. This type of razor 1 is sometimes referred to as refill cartridge razor 1 and basically consists of a reusable handle 5, to which a razor cartridge 10 is fitted. In such a case, the razor cartridge 10 can be removed from the handle 5 and replaced by a new razor cartridge 10, or a refurbished razor cartridge 10, once worn out. FIGS. 2A and 2B illustrate a razor cartridge 10 comprising a housing 12 and multiple razor blade assemblies 30 arranged in the housing 12. As is shown in FIG. 3C, each such razor blade assembly 30 comprises a blade support 32 and a razor blade 20 comprising a PFAS-free coating comprising an oxidized polyolefin wax and/or a partially oxidized polyolefin wax on surfaces 22, 24 of the cutting edge 26 of the razor blade 20.

Generally, the razor cartridge 10 comprises a cartridge housing 12, multiple razor blades 20, a retention spring (not shown) for the razor blades 20, an optional rubber strip (not shown), an optional hydration strip (not shown) and a cartridge holder 14 that attaches the razor cartridge 10 to the re-usable handle 5.

### EXAMPLES

### Example 1—Dip Coating

Four wax dispersions (D1-D4) were produced by dispersing 0.5% by weight of waxes W1-W4 in MilliQ water in clean glass vials and ultrasonicated for 30 min.
W1: Aquaslip® 656 wax emulsion by Lubrizol Corporation (non-ionic oxidized polyethylene (OPE) wax having a melting point of 130° C. and consisting of 35% by weight of solids);
W2: Aquaslip® 5071 wax emulsion by Lubrizol Corporation (non-ionic OPE wax having a melting point of 125° C. and consisting of 37% by weight of solids);
W3: Aquaslip® 677 wax emulsion by Lubrizol Corporation (anionic, non-ionic modified paraffin wax having a melting point of 64° C. and consisting of 30% by weight of solids); and
W4: Aquacer® 531 wax emulsion (non-ionic emulsion of a modified high density polyethylene wax) by BYK

Wax dispersions D1 and D2 were pre-heated in a water bath to 90° C., whereas wax dispersions D3 and D4 were kept in room temperature (RT, 20-23.5° C.).

Non-coated, after grinder, stainless steel razor blades made of Sandvik 13C26 razor blade steel with a strip thickness of 0.076 mm were placed in a blade holder and cleaned and surface activated with plasma treatment (Plasma Cleaner PDC-002-CE, Harrick Plasma) for 3 minutes at low setting. The cleaned and surface-activated razor blades were dipped in the wax dispersions D1-D4 and were slowly withdrawn therefrom after 1 s (D1, D2, D4) or 10 s (D3). The dip-coated razor blades were cured at 220±10° C. for 8 minutes in a lab oven (Memmert GmbH) for 8 minutes with high air flow (setting 5) (D1, D2, D4) or low air flow (setting 1) (D3).

The dip-coated and cured razor blades were dip coated a second time to provide a second layer of wax coating. The dip-coated blades were cured as described above. Razor blades coated with wax W1 were coated with three layers of wax W1, whereas razor blades coated with wax W2-W4 were coated with two layers of wax W2-W4. The cured and dip-coated razor blades were then cooled at RT for at least 1 hour before chop testing and investigation under microscope.

### Example 2—Spay Coating

The wax dispersion D2 was produced as described in Example 1.

The wax dispersion D2 was loaded into a spray gun (ANI F1/N/Super-S Airbrush, Ani Technologies) with a nozzle of 1.5 mm. The razor blades were cleaned and surface-activated as described in Example 1. The spray gun was connected to a nitrogen (N₂) source at 3±1 bar pressure and placed in an opening of spraying box. The blade holder with the cleaned and surface-activated razor blades was placed in the spraying box, which was closed to avoid contamination during spray coating. During spray coating, the spray gun was initially tilted up towards the lid of the spraying box, and then tilted down while spraying and sprayed straight onto the razor blades for 1±0.5 s, and then tilted up towards the lid where the spraying was stopped. The lid was removed after 3-5 minutes to reduce any contaminations.

The spray-coated razor blades were cured as described in Example 1. The cured and spray-coated razor blades were then cooled at room temperature for 5 min before repeating the spray coating process and curing a second time. The razor blades were allowed to cool at RT for 1 hour after the second curing step before chop testing and investigation under microscope.

### Example 3

Paper strips (Whatman™ Cellulose Chromatography Papers, Grade 17 Chr, Cytvia), 2 cm in width, 0.7 mm thickness and 5-10 cm in length, were dipped in MilliQ water for 5±1 s and then placed on the metal bar on a chop testing machine (WSL368 Chop Force Tester, Scientific Vacuum Systems Ltd with a Mecmesin digital force gauge). The chop testing machine was programmed to chop from a length of 10.43 mm from “Home” to 12.43 mm from “Home” so that the razor blades tested cut down the same depth into the paper each time. The chop testing machine was programmed to perform 5 chops for each razor blade unless otherwise specified. The first chop force and the maximum chop force were recorded for each razor blade. All chop force values presented herein are in Newton (N).

The first razor blade from each batch was saved for investigation under microscope. The last razor blade from each batch was not subject to chop testing and was saved for investigation under microscope. The results of the chop testing of the razor blades coated in Examples 1 and 2 are provided in Table 1. N in Table 1 represents 5 chops for each razor blade out of three razor blades giving a total of 15 chops, i.e., N=15.

TABLE 1
chop force

| | First chop force | Max chop force |
|---|---|---|
| Wax | (N = 15) | (N = 15) |
| Wax W1 - dip coated | 10.6 ± 0.6 | 16.8 ± 0.3 |
| Wax W2 - dip coated | 10.3 ± 0.6 | 15.6 ± 0.4 |
| Wax W3 - dip coated | 11.0 ± 0.0 | 17.3 ± 0.9 |
| Wax W4 - dip coated | 11.0 ± 0.0 | 16.9 ± 0.4 |
| Wax W2 - spray coated* | 10.0 ± 0.0 | 15.0 ± 1.0 |
| Non-coated razor blades | 27.0 ± 1.0 | 31.0 ± 0.5 |

*N = 80, 20 chops performed for 4 razor blades

### Example 4

Example 1 was repeated for wax dispersion D1 by comparing the effect of the chop force when using one dip coating and curing step as compared to using two dip coating and curing steps. The results from the chop force test are presented in Table 2.

TABLE 2
chop force

| | First chop force | Max chop force |
|---|---|---|
| Wax | (N = 15) | (N = 15) |
| Wax W1 - dual dip coat | 11.3 ± 0.6 | 14.6 ± 0.6 |
| Wax W1 - single dip coat | 13.3 ± 0.6 | 17.7 ± 0.9 |

Dual dip coating led to lower chop force as compared to single dip coating.

### Example 5

Example 1 was repeated for wax dispersion D1 produced by dispersing 0.1% or 0.5% by weight of wax W1 in water in clean glass vials and ultrasonicated for 30 min. The results from the chop force test are presented in Table 3.

TABLE 3
chop force

| | First chop force | Max chop force |
|---|---|---|
| Wax | (N = 15) | (N = 15) |
| Wax W1 - 0.5% wax | 10.6 ± 0.6 | 16.8 ± 0.3 |
| Wax W1 - 0.1% wax* | 15.3 ± 1.5 | 18.0 ± 2.5 |

*N = 10, 5 chops performed for 2 razor blades

Wax dispersion D1 comprising 0.5% by weight of wax W1 led to lower chop force as compared to wax dispersion D1 comprising 0.1% by weight of wax W1.

### Example 6

Example 1 was repeated for wax dispersion D1 by comparing pre-heating (90° C.) of the wax dispersion with no pre-heating (RT) of the wax dispersion. The results from the chop force test are presented in Table 4.

TABLE 4
chop force

| | First chop force | Max chop force |
|---|---|---|
| Wax | (N = 15) | (N = 15) |
| Wax W1 - pre-heating | 10.6 ± 0.6 | 16.8 ± 0.3 |
| Wax W1 - no pre-heating | 13.0 ± 0.0 | 18.0 ± 1.0 |

Pre-heating of the wax dispersion D1 led to low lower chop force as compared to no pre-heating of wax dispersion D1.

### Example 7

Example 1 was repeated for wax dispersion D2 by investigating the effect of submersing dip-coated razor blades in lukewarm (47° C.) water for 15 minutes to simulate a shower environment. The results from the chop force test are presented in Table 5.

TABLE 5
chop force

| | First chop force | Max chop force |
|---|---|---|
| Wax | (N = 15) | (N = 15) |
| Wax W2 - water treatment | 10.7 ± 0.6 | 12.9 ± 0.4 |
| Wax W2 - no water treatment | 10.3 ± 0.6 | 12.9 ± 0.1 |

The water treatment to simulate a shower environment did not have any significant effect on the chopping force.

### Example 8

Example 1 was repeated for wax dispersions D1-D3 by polishing the razor blades with a razor sharpener (RazorPit razor blade sharpener) prior to coating and following coating. The chopping force increased for all wax dispersion D1-D3 when polishing the razor blades with razor sharpener. The conclusion was that polishing the razor blades did not improve the chopping force or the adhesion of the coatings of the razor blades.

### Example 9

Example 1 was repeated for wax dispersions D1-D4 but with quenching of the coated razor blades in water (ice cold or RT) after the final curing step. The quenching did not improve the chopping force for any of the wax dispersions D1-D4. The first chop force with quenching was about 0.7-1 N higher for wax dispersions D1-D4 as compared to no quenching, whereas the max chop force was about the same for quenching as without quenching (First chop force: D1: 12.3±0.6; D2*: 11.0±0.0; D3: 11.7±0.6; D4: 12.0±1.0, Max chop force: D1: 16.7±1.0; D2*: 20.0±7; D3: 16.4±0.6; D4: 20.2±3.6, *5 chops with razor blades were performed for D2, whereas 5 chops with 3 razor blades were performed for D1, D3, D4).

Further, the quenching reduced the adhesion of the coatings of waxes W3 and W4 to the razor blades, whereas the quenching did not affect the adhesion of the coatings of waxes W1 and W2 to the razor blades. The adhesion of the coating was represented by the difference between the Max chop force and the First chop force, in which a large difference represents a low adhesion. The conclusion was that quenching in water after dip coating did not improve the chopping force or the adhesion of the coatings of the razor blades.

### Example 10

Example 1 was repeated for wax dispersion D2 but with quenching of the razor blades in water (RT) after the first curing step and prior to the second dip coating step. Quenching of the razor blades in water (RT) was also done once after the first curing step and omitting the second dip coating step, once after the first curing step and then a second time after the second curing step, or once after the second curing step. The quenching did not improve the chop force or the adhesion of the coating of wax W2 to the razor blades, see Table 6. The conclusion was that quenching in water in between dip coatings did not improve the chopping force or the adhesion of the coatings of the razor blades.

TABLE 6
chop force

| | First chop force | Max chop force |
|---|---|---|
| Wax | (N = 15) | (N = 15) |
| Wax W2 - dip, dip, no quenching | 10.3 ± 0.6 | 15.6 ± 0.4 |
| Wax W2 - dip, quench, dip | 10.7 ± 0.6 | 14.8 ± 0.7 |
| Wax W2 - dip, quench | 10.3 ± 0.6 | 14.5 ± 0.5 |
| Wax W2 - dip, quench, dip, quench | 11.0 ± 0.0 | 14.7 ± 0.6 |
| Wax W2 - dip, dip, quench | 11.7 ± 1.1 | 16.0 ± 1.4 |

### Example 11

Example 2 was repeated for wax dispersion D2 but with different durations of the spray coatings: 1 s, 4 s, and 10 s. The results of the chop testing are provided in Table 7.

TABLE 7
chop force

| | First chop force | Max chop force |
|---|---|---|
| Wax | (N = 15) | (N = 15) |
| Wax W2 - 1 s | 10.3 ± 0.6 | 15.6 ± 0.4 |
| Wax W2 - 4 s | 12.0 ± 0.0 | 18.2 ± 0.6 |
| Wax W2 - 10 s | 12.7 ± 1.5 | 19.0 ± 1.8 |

The shortest spray coating duration resulted in the lowest chop forces of the spray coated razor blades.

### Example 12

Example 1 was repeated for wax dispersions D1-D3 but with different curing temperatures and durations: 60° C. for 17 hours or 60° C. for 4 hours followed by 90° C. for 2 hours. Curing at 60° C. for 4 hours followed by 90° C. for 2 hours resulted in lower chopping force as compared to curing at 60° C. for 17 hours. However, the chopping forces at both these curing protocols were higher as compared to curing at 220° C. for 8 minutes as used in Example 1.

### Example 13

Example 1 was repeated for wax dispersions D1-D2 when curing directly after dip coating or after drying the dip coating in RT prior to curing. There was no significant difference in chop force when performing wet curing, i.e., directly after dip coating, versus dry curing, i.e., allowing the coating dry in room temperature prior to curing.

### Example 14

Example 1 was repeated for wax dispersions D5-D12 produced by dispersing 0.5% by weight of waxes W5-W12 in MilliQ water (W5) or butyl glycol (W6-W12) in clean glass vials and ultrasonicated for 30 min.
W5: Liquilube™ 404E wax emulsion by Lubrizol Corporation (non-ionic PE wax having a melting point of 136° C. and consisting of 35% by weight of solids);
W6: Lanco™ Glidd 7678 wax dispersion by Lubrizol Corporation (modified polyolefin wax having a melting point of 104° C., Dv50≤3.5 μm, Dv90≤7 μm, density=0.91 g/cm³ at 20° C. and consisting of 20% by weight of solids);
W7: Lanco™ Glidd 6635 wax dispersion by Lubrizol Corporation (polyolefin wax having a melting point of 111° C., Dv50≤10 μm, Dv90≤20 μm, density=1.00 g/cm³ at 20° C. and consisting of 64% by weight of solids);
W8: Ceraflour 1051 micronized modified polyethylene wax by BYK;
W9: Ceraflour 1050 micronized polyethylene wax by BYK;
W10: Ceraflour 1052 micronized modified polyethylene wax by BYK;
W11: Ceridust® 8330 renewable polymer/wax compound by Clariant; and
W12: Ceridust® 1060 vita micronized modified natural wax by Clariant.

The results of the chop testing are provided in Table 8.

TABLE 8
chop force

| | First chop force | Max chop force |
|---|---|---|
| Wax | (N = 15) | (N = 15) |
| Wax W5 - dip coated | 12.7 ± 0.6 | 16.4 ± 1.9 |
| Wax W6 - dip coated | 16.3 ± 0.6 | 18.5 ± 0.1 |
| Wax W7 - dip coated | 16.0 ± 1.0 | 19.5 ± 0.8 |
| Wax W8 - dip coated | 17.3 ± 0.5 | 20.3 ± 2.2 |
| Wax W9 - dip coated | 16.6 ± 0.6 | 19.2 ± 0.2 |
| Wax W10 - dip coated | 15.7 ± 0.6 | 19.1 ± 2.0 |
| Wax W11 - dip coated | 16.0 ± 0.0 | 18.9 ± 0.9 |
| Wax W12 - dip coated | 14.3 ± 0.6 | 17.5 ± 1.2 |

### Example 15

Example 1 was repeated for wax dispersion D1 but with additional cleaning of the razor blades following plasma treatment in hydrochloric acid (HCl) or sodium hydroxide (NaOH) solutions with pH of 1, 3, 5 (HCl solutions), 10, 12 or 14 (NaOH solutions). The razor blades were soaked for 20 minutes in the HCl or NaOH solutions, followed by rinsing with de-ionized water and drying. The razor blades where then coated with wax dispersion according to Example 1.

Treating the razor blades with acidic (HCl) or basic (NaOH) solutions following plasma treatment resulted in higher chop forces than merely treating the razor blades with plasma treatment.

### Example 16

Example 1 was repeated for wax dispersions D1-D1 but with curing performed for 4 hours at 60° C. followed by 2 hours at 90° C. or for 17 hours at 60° C. These two curing protocols resulted in variable but higher chopping forces than the curing protocol of Example 1.

### Example 17

Example 1 was repeated for wax dispersion D1 at a concentration of 0.5% by weight or 1% by weight using the following four different curing protocols: i) 310° C. for 1 minute in a furnace (Thermolyne benchtop muffle, type 47900), ii) 220° C. for 8 minutes in the lab oven or furnace, iii) 200° C. for 10 minutes in the lab oven, or iv) 180° C. for 15 minutes in the lab oven.

The wax dispersion at 0.5% by weight had lower chop forces than the wax dispersion at 1% by weight for all curing protocols. The curing protocol ii) resulted in the lowest first and max chop forces.

### Example 18

Example 1 was repeated for wax dispersion D1 at concentrations of 0.5% by weight, 1% by weight, and 2% by weight. The results are presented in Table 9.

TABLE 9
chop force

| | First chop force | Max chop force |
|---|---|---|
| Wax | (N = 15) | (N = 15) |
| Wax W1 - 0.5% by weight | 13.7 ± 2.1 | 17.6 ± 1.5 |
| Wax W1 - 1% by weight | 16.0 ± 4.4 | 20.3 ± 6.1 |
| Wax W1 - 2% by weight | 15.7 ± 1.1 | 20.0 ± 0.9 |

### Example 19

Example 1 was repeated for wax dispersion D1 at a concentration of 0.5% by weight using the following curing protocols: 120° C. for 30 minutes, 140° C. for 24 minutes, 160° C. for 19 minutes, 180° C. for 15 minutes, 200° C. for 11 minutes, and 220° C. for 8 minutes.

The chop forces were lowest when curing at 220° C. for 8 minutes followed by curing at 200° C. for 11 minutes. The lower curing temperatures resulted in higher chop forces.

### Example 20

Example 1 was repeated for wax dispersion D1 at a concentration of 0.5% by weight and 0.01% by weight and pre-heating the wax dispersions to 50° C. or 90° C.

The first and max chop forces were lower for 0.5% by weight wax dispersions as compared to 0.01% by weight dispersions. Pre-heating the wax dispersions to 90° C. resulted in lower first and max chop forces as compared to pre-heating to 50° C.

### Example 21

Example 1 was repeated for wax dispersion D2 and D3 investigating various process parameters as listed below relative to the process parameters used in Example 1 (pre-heating: 90° C., dual dip, high air flow (setting 5), slow heating from curing temperature, curing at 220° C. for 8 minutes, dipping duration: 1 s, wax concentration: 0.5% by weight).
Pre-heating of dispersion: no pre-heating (RT), pre-heating at 50° C.
No. of dips: single dip, triple dip
Air flow: low (setting 1), medium (setting 3)

Slow heating in the oven: either from RT, or from an oven pre-heated at 100° C. The sample was then warmed to the target temperature and the curing times were used once the target temperature was reached.
Curing: 100° C. for 8 minutes, 120° C. for 8 minutes, 140° C. for 8 minutes, 160° C. for 8 minutes, 180° C. for or 15 minutes, 200° C. for 8 or 15 minutes, 220° C. for 15 minutes
Dipping duration: 10 s, 4 s
Wax concentration: 1% by weight, 0.05% by weight

The results are presented in Table 10.

TABLE 10
chop force

| | | First chop force | Max chop force |
|---|---|---|---|
| Process parameter | Wax | (N = 15) | (N = 15) |
| Example 1 | W2 | 10.3 ± 0.6 | 12.9 ± 0.1 |
| | W3 | 12.0 ± 1.0 | 15.6 ± 2.4 |
| No pre-heating | W2 | 11.8 ± 1.4 | 14.4 ± 1.1 |
| | W3 | 11.0 ± 0.0 | 14.6 ± 0.2 |
| Pre-heating at 50° C. | W2 | 11.3 ± 0.6 | 14.4 ± 2.0 |
| | W3 | 11.0 ± 0.0 | 14.0 ± 0.9 |
| Single dip | W2 | 10.7 ± 0.6 | 13.7 ± 2.4 |
| | W3 | 9.7 ± 0.6 | 12.7 ± 0.5 |
| Triple dip | W2 | 11.0 ± 0.0 | 13.5 ± 0.2 |
| | W3 | 11.3 ± 0.6 | 14.8 ± 0.5 |
| Air flow low | W2 | 11.0 ± 0.0 | 14.1 ± 0.4 |
| | W3 | 11.3 ± 0.6 | 14.9 ± 0.2 |
| Air flow medium | W2 | 10.0 ± 0.0 | 13.6 ± 0.3 |
| | W3 | 11.3 ± 0.6 | 14.8 ± 1.1 |
| Slow heating RT | W2 | 14.0 ± 1.7 | 16.2 ± 1.1 |
| | W3 | 13.0 ± 0.0 | 15.9 ± 0.8 |
| Slow heating 100° C. | W2 | 12.0 ± 0.0 | 14.9 ± 0.1 |
| | W3 | 13.3 ± 0.6 | 17.0 ± 1.3 |
| Curing 100° C., 8 min | W2 | 16.0 ± 0.0 | 20.9 ± 0.6 |
| | W3 | 11.3 ± 0.6 | 14.2 ± 1.2 |
| Curing 120° C., 8 min | W2 | 15.7 ± 0.6 | 22.5 ± 4.0 |
| | W3 | 11.3 ± 0.6 | 15.3 ± 1.3 |
| Curing 140° C., 8 min | W2 | 13.3 ± 0.6 | 18.1 ± 1.2 |
| | W3 | 12.0 ± 1.0 | 15.6 ± 1.3 |
| Curing 160° C., 8 min | W2 | 10.7 ± 0.6 | 13.5 ± 0.2 |
| | W3 | 11.0 ± 0.0 | 14.5 ± 0.2 |
| Curing 180° C., 8 min | W2 | 12.0 ± 1.0 | 15.6 ± 1.0 |
| | W3 | 14.0 ± 0.0 | 17.0 ± 0.3 |
| Curing 180° C., 15 min | W2 | 11.0 ± 0.0 | 13.1 ± 0.1 |
| | W3 | 13.3 ± 0.6 | 17.6 ± 0.3 |
| Curing 200° C., 8 min | W2 | 10.3 ± 0.6 | 13.6 ± 1.2 |
| | W3 | 10.0 ± 0.0 | 13.8 ± 0.2 |
| Curing 200° C., 15 min | W2 | 11.7 ± 0.6 | 14.8 ± 0.4 |
| | W3 | 12.0 ± 0.0 | 16.0 ± 0.8 |
| Curing 220° C., 15 min | W2 | 12.0 ± 1.0 | 15.2 ± 1.0 |
| | W3 | 13.0 ± 1.0 | 16.6 ± 1.2 |
| Dipping duration: 10 s | W2 | 11.7 ± 1.2 | 15.1 ± 0.8 |
| | W3 | 11.3 ± 0.6 | 14.4 ± 0.4 |
| Dipping duration: 4 s | W2 | 10.0 ± 0.0 | 13.0 ± 0.1 |
| | W3 | 11.7 ± 0.6 | 15.5 ± 1.1 |
| Wax concentration: 1% by | W2 | 11.0 ± 0.0 | 13.0 ± 0.5 |
| weight | W3 | 11.7 ± 0.6 | 15.5 ± 0.9 |
| Wax concentration: 0.05% by | W2 | 10.3 ± 0.6 | 13.0 ± 0.6 |
| weight | W3 | 12.3 ± 0.6 | 15.7 ± 0.4 |

### Example 22

Example 1 was repeated by performing a dual coating process involving different wax dispersions according to Table 11.

TABLE 11
dual coating

| | | | | | | |
|---|---|---|---|---|---|---|
| Inner layer | W2 | W2 | W1 | W1 | W3 | W3 |
| Outer layer | W1 | W3 | W2 | W3 | W1 | W2 |

None of these combinations resulted in lower chop forces as compared to a dual coating with the same wax, i.e., W1+W1, W2+W2 or W3+W3.

### Example 23

Example 14 was repeated for wax dispersion D6 produced by dispersing 1.82 or 3.33% by weight of wax W6 (melting point 104° C.) in MilliQ water or butyl glycol in clean glass vials and ultrasonicated for 30 min.

### Water Solution

Plasma cleaned blades were dipped, 4 blades in each solution (1.82 or 3.33% by weight), and then allowed to dry overnight. Thereafter, each coating was cured at 109° (2 blades, above melting point of 104° C.) or at 102° C. (2 blades, below melting point of 104° C.) for 40 minutes.

Plasma cleaned blades were dipped, 4 blades in each solution (1.82 or 3.33% by weight), and then cured immediately at 109° (2 blades, above melting point of 104° C.) or at 102° C. (2 blades, below melting point of 104° C.) for 40 minutes.

The results of chop force testing are presented in Table 12.

TABLE 12
chop force

| | First chop force | Max chop force |
|---|---|---|
| Wax | (N = 15) | (N = 15) |
| Wax W6 - 3.33% by weight, | 24.5 ± 0.7 | 25.9 ± 0.4 |
| wet cured at 102° C. | | |
| Wax W6 - 3.33% by weight, | 22.0 ± 0.0 | 25.2 ± 2.6 |
| wet cured at 109° C. | | |
| Wax W6 - 1.82% by weight, | 23.5 ± 3.5 | 24.9 ± 4.7 |
| wet cured at 102° C. | | |
| Wax W6 - 1.82% by weight, | 27.0 ± 1.4 | 28.6 ± 1.4 |
| wet cured at 109° C. | | |
| Wax W6 - 3.33% by weight, | 19.5 ± 0.7 | 27.5 ± 1.3 |
| dry cured at 102° C. | | |
| Wax W6 - 3.33% by weight, | 18.5 ± 0.7 | 25.5 ± 1.7 |
| dry cured at 109° C. | | |
| Wax W6 - 1.82% by weight, | 19.0 ± 0.0 | 22.1 ± 0.3 |
| dry cured at 102° C. | | |
| Wax W6 - 1.82% by weight, | 16.5 ± 0.7 | 27.5 ± 1.3 |
| dry cured at 109° C. | | |

### Butyl Glycol Solution

Plasma cleaned blades were dipped, 3 blades in each solution (1.82 or 3.33% by weight), and then allowed to dry overnight. Thereafter, each coating was cured at 102° for 40 minutes. The results of chop force testing are presented in Table 13.

TABLE 13
chop force

| | First chop force | Max chop force |
|---|---|---|
| Wax | (N = 15) | (N = 15) |
| Wax W6 - 1.82% by weight, | 21.3 ± 1.2 | 24.0 ± 1.3 |
| cured at 102° C. | | |
| Wax W6 - 1.82% by weight, | 19.0 ± 1.0 | 27.3 ± 0.7 |
| cured at 109° C. | | |
| Wax W6 - 3.33% by weight, | 19.0 ± 0.0 | 20.6 ± 0.6 |
| cured at 102° C. | | |
| Wax W6 - 3.33% by weight, | 16.7 ± 5.8 | 29.0 ± 1.4 |
| cured at 109° C. | | |

### Example 24

Example 1 was repeated for three sets of wax dispersions D1-D3 prepared by dispersing 0.5% by weight of wax W1-W3 in MilliQ water and ultrasonicated for 30 min. To each set, 1, 3 or 5 drops of BYK®-349 (polyether-modified siloxane surfactant), corresponding to about 0.09% by weight, 0.28% by weight and 0.45% by weight of BYK®-349.

Addition of BYK®-349 to the wax dispersions did not improve the chop force.

### Example 25

Example 1 was repeated for wax dispersion D13 by dispersing 0.5% by weight of wax W13 in MilliQ water and ultrasonicated for 30 min.

W13: Hordamer PE 03 primary polyethylene dispersion with anionic and non-ionic emulsifiers by BYK.

Razor blades were coated as described in Example 1 for wax dispersion D2 and D4. The results are presented in Table 14.

TABLE 14
chop force

| | First chop force | Max chop force |
|---|---|---|
| Wax | (N = 15) | (N = 15) |
| Wax W13 | 13.0 ± 1.0 | 19.0 ± 0.9 |

### Example 26

Example 2 was repeated for wax dispersion D4 by dispersing 0.5% by weight of wax W4 and 2% by weight of binder B1 or B2 in MilliQ water and ultrasonicated for 30 min.
B1: CHP 555 APEO- and formaldehyde-free, anionic fine dispersed, aqueous dispersion of acrylic copolymer by CH-Polymers
B2: CHP 570 APEO- and formaldehyde-free, anionic acrylic copolymer by CH-Polymers

Coating was done by spray coating. Three different curing protocols were tested: 220° C. for 8 minutes, 180° C. for 8 minutes and 130° C. for 8 minutes.

None of the binders were degraded at any of the curing protocols. Addition of binders to the wax dispersion D4 did not improve the chop force.

### Example 27

Example 2 was repeated for wax dispersion D2 by dispersing 0.5% by weight of wax W2 and a 2% by binder B1 or B2 in MilliQ water and ultrasonicated for 30 min.

Coating was done by spray coating. Eight different curing protocols were tested: 220° C. for 8 minutes, 250° C. for 8 minutes, 280° C. for 8 minutes, 310° C. for 8 minutes, 340° C. for 8 minutes, 340° C. for 1 minute, 370° C. for 8 minutes, and 370° C. for 1 minute.

The lowest chop forces were obtained by curing at 220° C. for 8 minutes, 340° C. for 1 minute and 370° C. for 1 minute. The highest adhesion was seen for 370° C. for 1 minute. Binder B1 resulted in lower chop forces as compared to binder B2.

However, addition of binders to the wax dispersion D2 did not improve the chop force. The results are presented in Table 15.

TABLE 15
chop force

| | | First chop force | Max chop force |
|---|---|---|---|
| Curing protocol | Binder | (N = 15)* | (N = 15)* |
| 220° C. for | B1 | 17.5 ± 0.7 | 26.2 ± 0.8 |
| 8 minutes | B2 | 25.0 | 33.8 |
| 250° C. for | B1 | 22.5 ± 0.7 | 32.1 ± 2.1 |
| 8 minutes | B2 | 21.0 | 27.0 |
| 280° C. for | B1 | 26.0 ± 0.0 | 29.5 ± 0.8 |
| 8 minutes | B2 | 52.0 | 52.0 |
| 310° C. for | B1 | 28.5 ± 4.9 | 32.4 ± 1.7 |
| 8 minutes | B2 | 44.8 | 44.8 |
| 340° C. for | B1 | 31.5 ± 0.7 | 33.7 ± 1.5 |
| 8 minutes | B2 | 49.3 | 49.3 |
| 340° C. for | B1 | 18.5 ± 0.7 | 28.3 ± 1.3 |
| 1 minute | B2 | N/A | N/A |
| 370° C. for | B1 | 28.5 ± 2.1 | 33.5 ± 1.4 |
| 8 minutes | B2 | 46.8 ± 12.4 | 48.0 ± 10.7 |
| 370° C. for | B1 | 18.5 ± 2.1 | 24.9 ± 3.3 |
| 1 minute | B2 | N/A | N/A |

N/A—not applicable, i.e., not tested
*Only one razor blade was tested for B2

### Example 28

Example 2 was repeated for wax dispersion D2 by dispersing 0.5% by weight of wax W2 and a 1, 1.5 or 2% by binder B1 or B2 in MilliQ water and ultrasonicated for 30 min.

Coating was done by spray coating 1, 2 or 3 coatings and curing at 220° C. for 8 minutes.

Addition of binders to the wax dispersion D2 did not improve the chop force.

### Example 29

Example 1 was repeated for wax dispersion D2 by dispersing 0.5% by weight of wax W2 in MilliQ water and ultrasonicated for 30 min. Further, a binder dispersion BD2 was prepared by dispersing 0.25% by weight of binder B2 in MilliQ water and ultrasonicated for 30 min. The wax dispersion D2 was pre-heated to 90° C. and the binder dispersion BD2 was pre-heated to 40° C. Curing was performed at 225° C. for 8 minutes. Razor blades were dip coated according to the following coating protocols following plasma treatment:
1) Dip coating in binder dispersion BD2, curing, dip coating in wax dispersion D2, curing;
2) Dip coating in binder dispersion BD2, curing, dip coating in wax dispersion D2, curing, dip coating in wax dispersion D2, curing;
3) Dip coating in wax dispersion D2, curing, dip coating in binder dispersion BD2, curing;
4) Dip coating in wax dispersion D2, curing, dip coating in wax dispersion D2, curing, dip coating in binder dispersion BD2, curing;
5) Dip coating in wax dispersion D2, curing, dip coating in wax dispersion D2, curing

The coating protocols 3) and 5) resulted in the lowest chop force as shown in Table 16.

TABLE 16
chop force

| | First chop force | Max chop force |
|---|---|---|
| Coating protocol | (N = 40) | (N = 40) |
| 1 | 21.0 ± 4.2 | 32.0 ± 0.3 |
| 2 | 17.0 ± 1.4 | 28.8 ± 0.1 |
| 3 | 14.7 ± 0.6 | 15.2 ± 0.5 |
| 4 | 17.1 ± 1.6 | 17.6 ± 0.9 |
| 5* | 11.0 ± 0.0 | 16.1 ± 0.2 |

*20 chops using three razor blades giving N = 60 were performed for coating protocol 5), whereas 20 chops using two razor blades were performed for the other coating protocols.

### Example 30

Example 1 was repeated for wax dispersion D2 by dispersing 0.5% by weight of wax W2 in MilliQ water and ultrasonicated for 30 min. Further, a binder dispersion BD1 was prepared by dispersing 0.25% by weight of binder B1 in MilliQ water and ultrasonicated for 30 min. A binder dispersion BD3 was also prepared by dispersing 0.25% by weight of binder B3 in MilliQ water and ultrasonicated for 30 min.
B3: BRB Silanil® 581 aqueous solution of aminoalkyl silane by BRB International BV

The wax dispersion D2 was pre-heated to 90° C., the binder dispersion BD1 was pre-heated to 60° C. and the binder dispersion BD3 was pre-heated to 30° C. Curing was performed at 225° C. for 8 minutes. Razor blades were dip coated according to the following coating protocols following plasma treatment:
1) Dip coating in wax dispersion D2, curing, dip coating in binder dispersion BD1, curing, dip coating in wax dispersion D2, curing;
2) Dip coating in wax dispersion D2, curing, dip coating in binder dispersion BD1 or binder dispersion BD3, curing, dip coating in wax dispersion D2, curing;
3) Dip coating in wax dispersion D2, curing, dip coating in wax dispersion D2, curing, dip coating in binder dispersion BD1 or binder dispersion BD3, curing;
4) Dip coating in wax dispersion D2, curing, dip coating in binder dispersion BD1 or binder dispersion BD3, curing.

The results of the chop force test are presented in Table 17.

TABLE 17
chop force

| | First chop force | Max chop force |
|---|---|---|
| Coating protocol | (N* = 60) | (N* = 60) |
| 1 | 15.0 ± 1.0 | 16.9 ± 0.4 |
| 2, B1 | 15.0 ± 1.0 | 16.9 ± 0.4 |
| 2, B3 | 13.3 ± 0.6 | 15.9 ± 0.4 |
| 3, B1 | 16.9 ± 2.6 | 17.9 ± 1.0 |
| 3, B3 | 14.3 ± 0.6 | 21.1 ± 2.2 |
| 4, B1 | 12.7 ± 0.6 | 15.0 ± 0.3 |
| 4, B3 | 11.0 ± 0.0 | 14.6 ± 0.3 |

*20 chops with three razor blades

### Example 31

Razor blades were treated with air-plasma for 3 minutes at low setting. Dispersions were made by mixing the active substance with milli-Q water to a solid content concentration of 0.175% W2 (Aquaslip® 5071 (oxidized polyethylene (OPE) wax)) or 0.2 wt % of B3 (Silanil® 581 (water-based aminoalkyl silane solution)), followed by sonication in an ultrasonic bath for 30 minutes. The dispersions were preheated to 90° C. (D2, Aquaslip® 5071) and 40° C. (BD3, Silanil® 581), respectively, before applying to the plasma-treated blades. Firstly, BD3 was applied and allowed to dry in nitrogen (N₂), inert glove bag for 30 minutes. Thereafter, D2 was applied. The treated razor blades were placed in oven at 220° C. for 8 minutes with high air flow. The D2 dispersion was applied twice to the razor blades, with a curing step after each layer.

The results of the chop force test are presented in Table 18.

TABLE 18
average chop force

| | | Max chop | Max chop | Max chop | Max chop | Max chop |
|---|---|---|---|---|---|---|
| | First chop | force over | force over | force over | force over | force over |
| | force | chop 1-20 | chop 21-40 | chop 41-60 | chop 61-80 | chop 81-100 |
| Spray | 12.5 ± 0.7 | 14.5 ± 0.3 | 15.4 ± 0.1 | 16.0 ± 0.6 | 16.7 ± 0.4 | 17.3 ± 0.8 |
| coated | | | | | | |
| Dip | 11.3 ± 0.6 | 14.4 ± 0.5 | 15.7 ± 0.8 | 16.1 ± 0.3 | 16.4 ± 0.5 | 16.9 ± 1.0 |
| coated | | | | | | |

The process above was repeated by using a concentration of 0.1% for W2. The results of the chop force test are presented in Table 19.

TABLE 19
average chop force

| | | Max chop | Max chop | Max chop | Max chop | Max chop |
|---|---|---|---|---|---|---|
| | First chop | force over | force over | force over | force over | force over |
| | force | chop 1-20 | chop 21-40 | chop 41-60 | chop 61-80 | chop 81-100 |
| Spray | 12.5 ± 2.1 | 13.7 ± 1.1 | 12.6 ± 1.3 | 12.8 ± 0.1 | 12.5 ± 1.7 | 13.8 ± 0.6 |
| coated | | | | | | |
| Dip | 8.7 ± 1.2 | 10.4 ± 1.2 | 11.4 ± 2.3 | 10.8 ± 1.2 | 10.6 ± 0.2 | 11.0 ± 0.5 |
| coated | | | | | | |

### Example 32

In this Example the following base coating method was used. Razor blades (N=2 in Tables 20-25, 27, N=3 in Table 26) were treated with air-plasma for 3 minutes at a low setting. Dispersions were made by mixing the active substance with milli-Q water to a solid content concentration of 0.5 wt %, followed by sonication in an ultrasonic bath for 30 minutes. The dispersions were preheated to 90° C. before applying to the plasma-treated blades. The razor blades were placed in an oven at 220° C. for 8 minutes with high air flow. The dispersion was applied twice to the blades, with a curing step after each layer. All settings described below were based on this base method, and any modifications to the base method are indicated the left columns of the following tables.

TABLE 20
Carnauba wax: Aquacer@ 1541 (From BYK)

| | | First chop | Max chop force | First chop | Max chop force |
|---|---|---|---|---|---|
| | | force | over 20 chops | force | over 20 chops |
| Alterations to the base method | | 3 wt % | | 0.5 wt % | |
| Preheated | Room | 13.0 ± 0.0 | 23.2 ± 1.0 | 11.5 ± 0.7 | 18.9 ± 1.8 |
| solution | temperature | | | | |
| | 40° C. | 12.0 ± 0.0 | 19.4 ± 1.5 | 11.0 ± 0.0 | 17.8 ± 1.0 |
| | 90° C. | 13.0 ± 0.0 | 19.9 ± 2.5 | 11.0 ± 0.0 | 16.3 ± 0.3 |
| Oven air flow | Low | 11.5 ± 0.7 | 17.9 ± 0.4 | 11.0 ± 0.0 | 16.8 ± 1.2 |
| | Medium | 12.0 ± 0.0 | 18.3 ± 0.1 | 11.5 ± 0.7 | 17.6 ± 1.0 |
| Curing | 100° C. 40 min | 11.5 ± 0.7 | 19.1 ± 0.2 | 12.5 ± 0.7 | 16.9 ± 0.6 |
| temperature | | | | | |
| and time | 160° C. 20 min | 13.0 ± 1.4 | 21.4 ± 0.7 | 12.0 ± 0.0 | 18.4 ± 0.5 |
| Plasma setting | No plasma | 12.5 ± 0.7 | 19.6 ± 0.9 | 13.0 ± 0.0 | 19.5 ± 2.9 |

The initial chop forces and average chop forces over 20 chops using carnauba wax compared unfavorably with the OPE wax coating in Example 30.

TABLE 21
Carnauba wax: Aquacer ® 570 (From BYK)

| | | First chop | Max chop force | First chop | Max chop force |
|---|---|---|---|---|---|
| | | force | over 20 chops | force | over 20 chops |
| Alterations to the base method | | 3 wt % | | 0.5 wt % | |
| Preheated | Room | 11.0 ± 0.0 | 19.5 ± 0.8 | 12.0 ± 1.4 | 19.7 ± 1.4 |
| solution | temperature | | | | |
| | 40° C. | 11.0 ± 0.0 | 23.6 ± 6.2 | 11.5 ± 0.7 | 21.1 ± 3.0 |
| | 90° C. | 11.5 ± 0.7 | 18.9 ± 0.3 | 11.5 ± 0.7 | 19.1 ± 1.0 |
| Oven air flow | Low | 12.0 ± 1.4 | 23.6 ± 7.2 | 11.5 ± 0.7 | 19.2 ± 0.7 |
| | Medium | 11.5 ± 0.7 | 21.79 ± 0.071 | 11.0 ± 0.0 | 19.1 ± 1.3 |
| Curing | 100° C. 40 min | 13.5 ± 2.1 | 24.48 ± 0.97 | 11.0 ± 0.0 | 20.5 ± 1.2 |
| temperature | | | | | |
| and time | 160° C. 20 min | 19.0 ± 0.9 | 28.93 ± 8.14 | 11.5 ± 0.7 | 18.8 ± 0.7 |
| Plasma setting | No plasma | 12.5 ± 0.7 | 21.83 ± 0.021 | 12.0 ± 0.0 | 21.4 ± 0.0 |

The average first chop forces and average maximum chop forces over 20 chops using carnauba compared unfavorably with the OPE wax coating in Example 30.

The base method for the carnauba wax (Aquaslip® 952 (from Lubrizol)) was the same as described above. However, in this experiment the adhesion promoter Silanil® 581 (B3) was used. This was done by mixing 0.2 wt % of Silanil® 581 with milli-Q Water. Silanil® 581 dispersion was preheated to 40° C. and applied to the plasma treated blades. Thereafter the Silanil® 581 film was allowed to rest for 30 minutes before applying the wax dispersion, curing and applying the second layer.

TABLE 22
Carnauba wax: Aquaslip ® 952 + adhesion promoter Silanil ® 581

| | Average | Max chop | Max chop | Max chop | Max chop | Max chop |
|---|---|---|---|---|---|---|
| | first chop | force over | force over | force over | force over | force over |
| | force | chop 1-20 | chop 21-40 | chop 41-60 | chop 61-80 | chop 81-100 |
| Silanil ® 581 + | 13.5 ± 0.7 | 19.4 ± 2.4 | 21.6 ± 2.0 | 22.7 ± 1.5 | 24.3 ± 2.8 | 27.1 ± 1.3 |
| Aquaslip ® 952 | | | | | | |

The average first chop force and average maximum chop forces over multiple chops using carnauba wax and adhesion promoter compared highly unfavorably with the wax coating in Example 30.

The base method for the wax W5 (high density polyethylene emulsion: Liquilube® 404E (Lubrizol) was the same as described above. However, in this experiment the adhesion promoter Silanil® 581 was used.

TABLE 23
High density polyethylene emulsion: Liquilube ® 404E + adhesion promoter Silanil ® 581

| | | Max chop | Max chop | Max chop | Max chop | Max chop |
|---|---|---|---|---|---|---|
| | First chop | force over | force over | force over | force over | force over |
| | force | chop 1-20 | chop 21-40 | chop 41-60 | chop 61-80 | chop 81-100 |
| Silanil ® 581 + | 12.0 ± 1.4 | 14.3 ± 0.5 | 15.1 ± 0.3 | 16.8 ± 0.9 | 16.6 ± 0.1 | 17.7 ± 0.9 |
| Liquilube ® 404E | | | | | | |

The average first chop force and average maximum chop forces over multiple chops using high density polyethylene wax and adhesion promoter compared highly unfavorably with the wax coating in Example 30.

The base method for the wax W4 (non-ionic emulsion of a modified high density polyethylene wax: Aquacer® 531 (BYK)) was the same as described above. However, in this experiment the adhesion promoter Silanil 581 was used.

TABLE 24
non-ionic emulsion of a modified high density polyethylene
wax: Aquacer ® 531 + adhesion promoter Silanil ® 581

| | | Max chop | Max chop | Max chop | Max chop | Max chop |
|---|---|---|---|---|---|---|
| | First chop | force over | force over | force over | force over | force over |
| | force | chop 1-20 | chop 21-40 | chop 41-60 | chop 61-80 | chop 81-100 |
| Silanil ® 581 + | 17.0 ± 1.4 | 19.5 ± 3.4 | 21.0 ± 3.6 | 22.0 ± 3.7 | 23.2 ± 4.5 | 23.9 ± 5.5 |
| Aquacer ® 531 | | | | | | |

The average first chop force and average maximum chop forces over multiple chops using non-ionic emulsion of a modified high density polyethylene wax and adhesion promoter compared highly unfavorably with the wax coating in Example 30.

TABLE 25
Polypropylene wax: Aquaslip@ 662 (From Lubrizol)

| | First chop | Max chop force |
|---|---|---|
| | force | over 5 chops |
| Single layer (Aquaslip ® 662) | 27.0 ± 1.4 | 27.3 ± 0.5 |
| Base method (Aquaslip ® 662) | 26.0 ± 0.0 | 28.3 ± 0.5 |
| Silanil ® 581 + Aquaslip ® 662 | 23.0 ± 1.4 | 24.6 ± 0.7 |

The average first chop force and average maximum chop forces over multiple chops using polypropylene wax or polypropylene wax and adhesion promoter compared highly unfavorably with the wax coating in Example 30.

TABLE 26
Paraffin wax: Aquaslip ® 678 (From Lubrizol)

| | First | Max chop force |
|---|---|---|
| | chop force | over 20 chops |
| Base method (except | 10.5 ± 0.7 | 12.4 ± 0.7 |
| solid concentration of 0.05 wt | | |
| % and oven air flow was medium) | | |
| Silanil ® 581 + Aquaslip ® 678 | 13.0 ± 1.4 | 14.1 ± 0.5 |
| Base method followed by | 28.3 ± 7.2 | 29.0 ± 7.5 |
| placing in 70° C. water for | | |
| 10 minutes | | |
| Base method followed by | 20.5 ± 2.1 | 23.8 ± 1.4 |
| placing in 100° C. water for | | |
| 10 minutes | | |

While paraffin wax resulted in reasonable chop forces, the results were significantly deteriorated when exposing the coated razor blades to hot water. Accordingly, the paraffin wax is not suitable as coating for razor blades as the chop forces significantly increased following exposure to hot water.

The treatment of the coated razor blades with hot water was repeated for razor blades coated with OPE wax W2 (Aquaslip® 5071) using the base method. The results are presented in Table 27.

TABLE 27
OPE wax: Aquaslip ® 5071

| | First chop | Max chop force |
|---|---|---|
| | force | over 20 chops |
| Base method | 10.5 ± 0.7 | 12.0 ± 0.7 |
| Base method followed by | 12.0 ± 0.0 | 13.4 ± 0.6 |
| placing in 70° C. | | |
| water for 10 | | |
| minutes | | |
| Base method followed by | 13.0 ± 0.0 | 16.8 ± 0.8 |
| placing in 100° C. | | |
| water for 10 | | |
| minutes | | |

The OPE wax coating showed low chop force also when exposed to hot water and thereby outperformed the paraffin wax coating in terms of usability in razor blades that will be exposed to hot water during actual use.

### Example 33

Dispersions were made by mixing the active substance with milli-Q water to a solid content concentration of 0.175% W2 (Aquaslip® 5071 (oxidized polyethylene (OPE) wax)) or 0.2 wt % of B3 (Silanil® 581 (water-based aminoalkyl silane solution)), followed by sonication in an ultrasonic bath for 30 minutes. Razor blades were pre-heated in a furnace at 400° C., no air flow for 5 minutes then immediately treated with air-plasma for 3 minutes at low setting (160-180° C.). The dispersions were preheated to 90° C. (D2, Aquaslip® 5071) and 40° C. (BD3, Silanil® 581), respectively, before applying to the plasma-treated razor blades. Firstly, BD3 was applied by dip coating while the razor blades were still at elevated temperature (in the range 50° C. to 200° C., more specifically between 160° C. and 180° C.) and allowed to dry in ambient air for 30 minutes. Thereafter, D2 was applied by spraying for 1 s. The treated razor blades were placed in oven at 220° C. for 8 minutes with high air flow. The D2 dispersion spray and cure steps were then repeated once. Chop testing was performed on blade type a for 7 blades and for blade type b for 9 blades.

TABLE 28
Silanil ® 581, OPE wax: Aquaslip ® 5071 × 2

| Silanil ® 581 + | | Max chop | Max chop | Max chop | Max chop | Max chop |
|---|---|---|---|---|---|---|
| Aquaslip ® | First chop | force over | force over | force over | force over | force over |
| 5071 × 2 | force | chop 1-20 | chop 21-40 | chop 41-60 | chop 61-80 | chop 81-100 |
| Blade type a | 7.7 ± 0.5 | 10.5 ± 0.6 | 11.0 ± 0.6 | 11.3 ± 0.5 | 11.8 ± 0.7 | 12.2 ± 0.6 |
| Blade type b | 7.3 ± 0.5 | 9.8 ± 1 | 10.6 ± 1.3 | 11.4 ± 1.6 | 11.6 ± 1.7 | 11.9 ± 2 |

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method of coating a razor blade comprising coating surfaces of a cutting edge of the razor blade with an oxidized polyolefin wax and/or a partially oxidized polyolefin wax to form a per- and polyfluoroalkyl, PFAS, free coating comprising the oxidized polyolefin wax and/or the partially oxidized polyolefin wax.

2. The method according to claim 1, further comprising cleaning the surfaces of at least the cutting edge with plasma cleaning.

3. The method according to claim 1, further comprising dispersing the oxidized polyolefin wax and/or the partially oxidized polyolefin wax in a dispersion medium to form a dispersion comprising the oxidized polyolefin wax and/or the partially oxidized polyolefin wax at a concentration selected within an interval of from 0.01 up to 2% by weight, wherein coating the surfaces of the cutting edge comprises coating the surfaces of the cutting edge with the dispersion comprising the oxidized polyolefin wax and/or the partially oxidized polyolefin wax.

4. The method according to claim 3, wherein the dispersion medium is selected from the group consisting of water, an C1-C4 alcohol, a glycol and a glycol ether.

5. The method according to claim 3, further comprising heating the dispersion comprising the oxidized polyolefin wax and/or the partially oxidized polyolefin wax at a temperature above the glass transition temperature of the oxidized polyolefin wax and/or the partially oxidized polyolefin wax but below a melting temperature of the oxidized polyolefin wax and/or the partially oxidized polyolefin wax.

6. The method according to claim 3, further comprising coating the surfaces of the cutting edge with a binder and/or adhesion dispersion comprising a binder and/or an adhesion promoter to form adhesion- and/or binder-coated surfaces of the cutting edge, wherein coating the surfaces of the cutting edge comprises coating the adhesion- and/or binder-coated surfaces of the cutting edge with the dispersion comprising the oxidized polyolefin wax and/or the partially oxidized polyolefin wax.

7. The method according to claim 3, wherein coating the surfaces of the cutting edge comprises dip coating the surfaces of the cutting edge by dipping the cutting edge of the razor blade in the dispersion comprising the oxidized polyolefin wax and/or the partially oxidized polyolefin wax.

8. The method according to claim 7, wherein dip coating comprises:
dipping the cutting edge of the razor blade in the dispersion comprising the oxidized polyolefin wax and/or the partially oxidized polyolefin wax; and
curing the dip coated cutting edge at a temperature selected within an interval of from 100° C. up to 450° C. for a period of time selected within an interval of from 1 s up to up to 30 min.

9. The method according to claim 8, further comprising repeating dipping the cutting edge and curing the dip coated cutting edge at least once.

10. The method according to claim 7, further comprising spray coating the surfaces of the cutting edge with a spray gun loaded with a binder and/or adhesion dispersion comprising a binder and/or an adhesion promoter or dipping the cutting edge of the razor blade in the binder and/or adhesion dispersion.

11. The method according to claim 10, wherein spray coating the surfaces of the cutting edge with the spray gun loaded with the binder and/or adhesion dispersion or dipping the cutting edge of the razor blade in the binder and/or adhesion dispersion is performed prior to the first dipping the cutting edge of the razor blade in the dispersion comprising the oxidized polyolefin wax and/or the partially oxidized polyolefin wax and/or in between curing the dip coated cutting edge and dipping the cutting edge of the razor blade in the dispersion comprising the oxidized polyolefin wax and/or the partially oxidized polyolefin wax and/or after curing the dip coated cutting edge following the last dipping the cutting edge of the razor blade in the dispersion comprising the oxidized polyolefin wax and/or the partially oxidized polyolefin wax.

12. The method according to claim 3, wherein coating the surfaces of the cutting edge comprises spray coating the surfaces of the cutting edge with a spray gun loaded with the dispersion comprising the oxidized polyolefin wax and/or the partially oxidized polyolefin wax.

13. The method according to claim 12, wherein spray coating the surfaces of the cutting edge comprises spray coating the surfaces of the cutting edge with the spray gun loaded with the dispersion comprising the oxidized polyolefin wax and/or the partially oxidized polyolefin wax while providing a relative movement between the razor blade and the spray gun.

14. The method according to claim 13, wherein spray coating comprises:
spray coating the surfaces of the cutting edge with the spray gun loaded with the dispersion comprising the oxidized polyolefin wax and/or the partially oxidized polyolefin wax; and
curing the spray coated cutting edge at a temperature selected within an interval of from 100° C. up to 450° C. for a period of time selected within an interval of from 1 s up to up to 30 min.

15. The method according to claim 14, further comprising repeating spray coating the surfaces of the cutting edge and curing the spray coated cutting edge at least once.

16. The method according to claim 12, further comprising spray coating the surfaces of the cutting edge with a spray gun loaded with a binder and/or adhesion dispersion comprising a binder and/or an adhesion promoter or dipping the cutting edge of the razor blade in the binder and/or adhesion dispersion.

17. The method according to claim 16, wherein spray coating the surfaces of the cutting edge with the spray gun loaded with the binder and/or adhesion dispersion or dipping the cutting edge of the razor blade in the binder and/or adhesion dispersion is performed prior to the first spraying the surfaces of the cutting edge with the spray gun loaded with the dispersion comprising the oxidized polyolefin wax and/or the partially oxidized polyolefin wax and/or in between curing the spray coated cutting edge and spraying the surfaces of the cutting edge with the spray gun loaded with the dispersion comprising the oxidized polyolefin wax and/or the partially oxidized polyolefin wax and/or after curing the dip coated cutting edge following the last spraying the surfaces of the cutting edge with the spray gun loaded with the dispersion comprising the oxidized polyolefin wax and/or the partially oxidized polyolefin wax.

18. The method according to claim 16, wherein the binder and/or adhesion dispersion comprises the binder and/or the adhesion promoter dispersed in a dispersion medium selected from the group consisting of water, an C1-C4 alcohol, glycol and a glycol ether and at a concentration selected within an interval of from 0.025 up to 1.5% by weight.

19. The method according to claim 16, wherein
the binder is selected from the group consisting of a silane binder, a siloxane binder, a polymeric binder, and any combination thereof; and
the adhesion promoter is selected from the group consisting of a siloxane adhesion promoter, a silane adhesion promoter, and any combination thereof.

20. The method according to claim 1, wherein
the oxidized polyolefin wax is selected from a group consisting of an oxidized polyethylene, OPE, wax, and an oxidized polypropylene, OPP wax; and/or
the partially oxidized polyolefin wax is selected from the group consisting of a partially oxidized polyethylene, POPE, wax, and a partially oxidized polypropylene, POPP, wax.

21. The method according to claim 20, wherein
the oxidized polyolefin wax is an OPE wax; and/or
the partially oxidized polyolefin wax is a POPE wax.

22. A razor blade comprising a cutting edge comprising a per- and polyfluoroalkyl, PFAS, free coating comprising an oxidized polyolefin wax and/or a partially oxidized polyolefin wax on surfaces of the cutting edge.

23. The razor blade according to claim 22, wherein the cutting edge comprises a polytetrafluoroethylene, PTFE, free coating comprising the oxidized polyolefin wax and/or the partially oxidized polyolefin wax on the surfaces of the cutting edge.

24. The razor blade according to claim 22, wherein the razor blade is made of steel.

25. The razor blade according to claim 22, wherein
the razor blade comprises a surface coating on the surfaces of the cutting edge;
the surface coating is a diamond-like carbon, DLC, coating, a chromium nitride coating, a chromium coating, a titanium diboride coating, or a tungsten carbide coating; and
the PFAS-free coating comprising the oxidized polyolefin wax and/or the partially oxidized polyolefin wax is provided on the surface coating.

26. The razor blade according to claim 22, wherein
the oxidized polyolefin wax is selected from the group consisting of an oxidized polyethylene, OPE, wax and an oxidized polypropylene, OPP, wax; and/or
the partially oxidized polyolefin wax is selected from the group consisting of a partially oxidized polyethylene, POPE, wax and a partially oxidized polypropylene, POPP, wax.

27. The razor blade according to claim 26, wherein
the oxidized polyolefin wax is an OPE wax; and/or
the partially oxidized polyolefin wax is a POPE wax.

28. The razor blade according to claim 22, wherein the PFAS-free coating comprises an adhesion promoter and/or binder layer on the surfaces of the cutting edge, wherein the oxidized polyolefin wax and/or the partially oxidized polyolefin wax is provided on the adhesion promoter and/or binder layer.

29. The razor blade according to claim 22, wherein the PFAS-free coating comprises multiple layers of the oxidized polyolefin wax and/or the partially oxidized polyolefin wax on the surfaces of the cutting edge.

30. The razor blade according to claim 29, wherein the PFAS-free coating comprises at least one binder and/or adhesion layer comprising a binder and/or an adhesion promoter, wherein the at least one binder and/or adhesion layer is provided on the multiple layers of oxidized polyolefin wax and/or the partially oxidized polyolefin wax and/or in between two layers of the multiple layers of the oxidized polyolefin wax and/or the partially oxidized polyolefin wax and/or on the surfaces of the cutting edge.
